(19) United States
(12) Patent Application Publication
(10) Pub. No.: US 2010/0168346 A1
(43) Pub. Date: Jul. 1, 2010

(54) Sulfonated Poly (Arylene Ether) Containing Crosslinkable Moiety at End Group, Method of Manufacturing the Same, and Polymer Electrolyte Membrane Using the Sulfonated Poly (Arylene Ether) and the Method

(76) Inventors: Jae-Suk Lee, Gwangju (KR); Kwan-Soo Lee, Gwangju (KR); Myung-Hwan Jeong, Gwabgju (KR)

Correspondence Address: HARNESS, DICKEY & PIERCE, P.L.C., P.O. BOX 8910, RESTON, VA, 20195, US

(21) Appl. No.: 12/086,489

(22) PCT Filed: Mar. 6, 2007
(86) PCT No.: PCT/KR2007/001117

§ 371 Date: Jun. 13, 2008

(30) Foreign Application Priority Data
Nov. 22, 2006 (KR) 10-2006-0115549
Mar. 6, 2007 (KR) 10-2007-0022224

(51) Int. Cl. C08G 65/32

(52) U.S. Cl. 525/534

(57) ABSTRACT

A sulfonated polyUrylene ether) copolymer, a method of preparing the same, and a polymer electrolyte membrane using the sulfonated poly(arylene ether) copolymer are provided. A sulfonated poly(arylene ether) copolymer containing a sulfonic acid is synthesized by poly condensing a dihydroxy monomer having a sulfonate group with a dihalide monomer, or by polycondensing a dihalide monomer having a sulfonate group with a dihydroxy monomer. Moreover, a crosslinkable dihydroxy monomer or a crosslinkable dihalide monomer is polycondensed with the obtained poly(arylene ether) copolymer, thus enable crosslinking between polymers. A polymer electrolyte membrane for a fuel cell formed using a poly(arylene ether) copolymer containing a crosslinkable moiety maintains the equivalent or superior levels to existing sulfonated poly(arylene ether) polymer or the Nafion membrane commercially available at present in terms of thermal stability, mechanical stability, chemical properties, film formability, and the like, and shows considerably improved proton conductivity and cell performances.

### TECHNICAL FIELD

The present invention relates to a sulfonated poly(arylene ether) copolymer, a method of preparing the same, and a polymer electrolyte membrane using the sulfonated poly(arylene ether) copolymer and, more particularly, to a sulfonated poly(arylene ether) copolymer containing a crosslinkable moiety at the ends thereof, a method of preparing the same, and a polymer electrolyte membrane using the sulfonated poly(arylene ether) copolymer.

### BACKGROUND ART

A fuel cell, invented by William Grove in 1893, is an electrochemical energy conversion system that converts chemical energy into electric energy by an electrochemical reaction. The fuel cells had been used for special purposes such as Gemini spacecraft in the 1960's. Since the end of 1980's, extensive research and development for the fuel cells have continued to progress throughout the world as a power source of zero emission vehicles (ZEVs) and as an alternative energy to cope with explosive population growth and to meet an increase in electricity demand. Especially, since regulations on carbon dioxide emissions by the Green Round such as the United Nations Framework Convention on Climate Change (UNFCCC), motor vehicle exhaust emission regulations through mandatory sales requirements for low emission vehicle sales, and the like are imminent, automobile manufacturers of the world have tried to develop the zero emission vehicles such as a fuel cell vehicle in a hurry. Moreover, the fuel cell can be applied directly to small-scale power generation systems installed in a building, in a local area, etc., mobile communications, power generation for military applications such as submarine, etc. and the like. Although the fuel cell has no capability to store electricity, it has numerous advantages in that its fuel efficiency is higher than those of existing internal combustion engines as a power generation system, it consumes a small amount of fuel, and it is a clean and high efficiency power generation system that hardly exhausts environmental hazardous materials such as sulfur oxides (SOx), nitrogen oxides (NOx), etc. Accordingly, it is expected that the fuel cell will serve as a solution to the environmental problems caused by the use of fossil fuels.

Polymer electrolytes used as cation exchange resins or cation exchange membranes in the fuel cells have been utilized for several decades and extensively studied. Recently, numerous research on the cation exchange membranes capable of transporting cations used in a direct methanol fuel cell (DMFC), or a polymer electrolyte membrane fuel cell (PEMFC) (solid polymer electrolyte fuel cell, solid polymer fuel cell, or proton exchange membrane fuel cell) have continued to progress.

One of the most widely used cation exchange membranes in the fuel cell field is a Nafion™ membrane that is a perfluorinated sulfonic acid polymer produced by DuPont de Nemours in U.S.A. This membrane has an ionic conductivity of 0.1 S/cm, excellent mechanical strength and chemical resistance at the highest water content. Moreover, the Nafion™ membrane shows improved thermal stability as much as it can be applied to a fuel cell for a vehicle. Other commercially-available membranes having similar properties include Aciplex-S™ membrane manufactured by Asahi Chemical Industry Co., Ltd., Dow membrane by Dow Chemical Company, Flemion™ membrane by Asahi Glass Co., Ltd., Goreselect™ by Gore & Associates, and the like. Moreover, the Canadian company Ballard Power Systems Inc. has developed alpha, beta perfluorinated polymers.

However, the above membranes have drawbacks in that they are of high price, mass production is extremely difficult due to their complicated synthesis process, and their efficiency as cation exchange membranes is considerably decreased due to methanol crossover in an electric energy system such as a direct methanol fuel cell (DMFC) and a low proton conductivity at high or low temperature, thus being used in a limited manner.

Due to such drawbacks, extensive research on non-fluorinated and partially fluorine-substituted polymer electrolyte membranes (PEM) have continued to progress. As typical examples, there are sulfonated poly(phenylene oxide) membranes, poly(phenylene sulfide) membranes, polysulfone membranes, poly(para-phenylene) membranes, polystyrene membranes, polyetheretherketone membranes, polyamide membranes, and the like.

However, such polymer electrolyte membranes have some drawbacks in that, as their ion conductivities are in proportion to sulfonated degrees, if they are sulfonated above the critical concentration, a decrease in molecular weights is unavoidable and they cannot be used for a long time when hydrated due to a decrease in mechanical properties. In order to solve such drawbacks, a method for preparing a polymer using a sulfonated monomer and a method for selectively sulfonating a polymer have been developed (U.S. Pat. Nos. 5,468,574; 5,679,482; and 6,110,616). However, they have not completely achieved high-temperature stability and solved problems caused by a long-term use.

Meanwhile, U.S. Pat. No. 6,245,881 has disclosed a sulfonated polyimide prepared by sulfonation induced directly to a main chain of a polyimide, and sulfonated polyimides of various types prepared using diamine monomers containing sulfonic acid groups, having a thermal stability and oxidation-reduction stability higher than conventional proton-conductive polymers.

However, it has some problems in that, if the polymer is selectively sulfonated, it may cause a decrease in mechanical properties due to the sulfonation and, if the sulfonic acid diamine monomers are used, the reactivity and the film formation are not ensured uniformly due to low solubility for solvent.

Accordingly, it is necessary to provide a method for preparing a new material having excellent electrochemical properties and high-temperature stability and easily manufactured as a thin film.

### DISCLOSURE

### Technical Problem

Accordingly, it is a first object of the present invention to provide a sulfonated poly(arylene ether) copolymer containing a crosslinkable moiety at the ends thereof.

Moreover, it is a second object of the present invention to provide a method of preparing a sulfonated poly(arylene ether) copolymer for achieving the first object.

### Technical Solution

To accomplish the first object of the present invention, there is provided a sulfonated poly(arylene ether) copolymer containing a crosslinkable moiety at the ends thereof, represented by the following Formula 1:

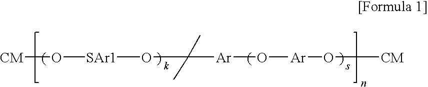

wherein SAr1 represents a sulfonated aromatic group, Ar represents a non-sulfonated aromatic group, and CM represents a crosslinkable moiety.

Moreover, in the above Formula, k has a value in the range of 0.001 to 1.000, s has a value of (1−k), and n represents an integer from 10 to 500 to represent a repeating unit of a polymer.

Furthermore, the first object of the present invention can be achieved by providing a sulfonated poly(arylene ether) copolymer containing a crosslinkable moiety at the ends thereof, represented by the following Formula 4:

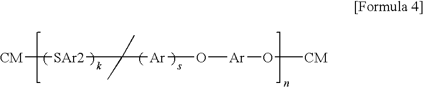

wherein SAr2 represents a sulfonated aromatic group, Ar represents a non-sulfonated aromatic group, and CM represents a crosslinkable moiety.

Moreover, in the above Formula, k has a value in the range of 0.001 to 1.000, s has a value of (1−k), and n represents an integer from 10 to 500 to represent a repeating unit of a polymer.

To accomplish the second object of the present invention, there is provided a method of preparing a sulfonated poly(arylene ether) copolymer containing a crosslinkable moiety at the ends thereof using a substitution reaction by polycondensation at the ends of a polymer prepared using a dihydroxy monomer and a dihalide monomer.

### DESCRIPTION OF DRAWINGS

FIG. 1 shows a ¹H-NMR spectrum of a sulfonated poly(arylene ether) copolymer (E-SPAE-HQ) containing a crosslinkable moiety at the ends thereof in accordance with the present invention;

FIG. 2 shows a ¹⁹H-NMR spectrum of a sulfonated poly(arylene ether) copolymer (E-SPAE-HQ) containing a crosslinkable moiety at the ends thereof in accordance with the present invention;

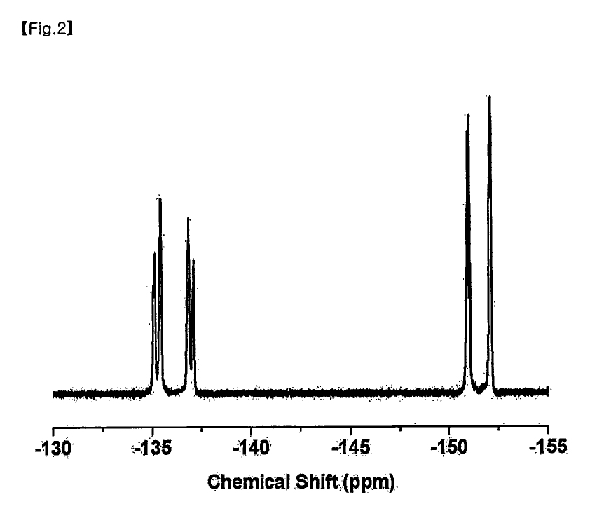

FIG. 3 shows a ¹H-NMR spectrum of a sulfonated poly(arylene ether) copolymer (E-SPAE-HQ) containing a crosslinkable moiety at the ends thereof in accordance with the present invention;

FIG. 4 shows a ¹H-NMR spectrum of an ethynylphenol monomer

FIG. 5 shows ¹⁹F-NMR spectrum of a sulfonated poly(arylene ether) copolymer (E-SPAE-HQ) containing a crosslinkable moiety at the ends thereof in accordance with the present invention;

FIG. 6 shows IR spectrum of a sulfonated poly(arylene ether) copolymer (E-SPAE-HQ) containing a crosslinkable moiety at the ends thereof in accordance with the present invention;

FIG. 7 is a graph showing a glass transition temperature (Tg) of a sulfonated poly(arylene ether) copolymer (E-SPAE-HQ) containing a crosslinkable moiety at the ends thereof in accordance with the present invention;

FIG. 8 is a graph showing a glass transition temperature (Tg) of a crosslinked polymer electrolyte membrane (CSPAE-HQ);

FIG. 9 is a graph showing a polarization curve of a Nafion 117 membrane and a crosslinked polymer electrolyte membrane (CSPAE-HQ) based on variations in temperature and time;

FIG. 10 is a graph showing a power density of a Nafion 117 membrane and a crosslinked polymer electrolyte membrane (CSPAE-HQ) based on variations in temperature and time; and

FIG. 11 is photographs showing a crosslinked polymer electrolyte membrane.

### MODE FOR INVENTION

Hereinafter, preferred embodiments in accordance with the present invention will be described with reference to the accompanying drawings.

### Example 1

A sulfonated poly(arylene ether) copolymer in accordance with Example 1 of the present invention has a crosslinkable moiety at the ends thereof. The sulfonated poly(arylene ether) copolymer is represented by the following Formula 1:

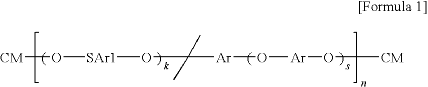

wherein SAr1 represents a sulfonated aromatic group such as

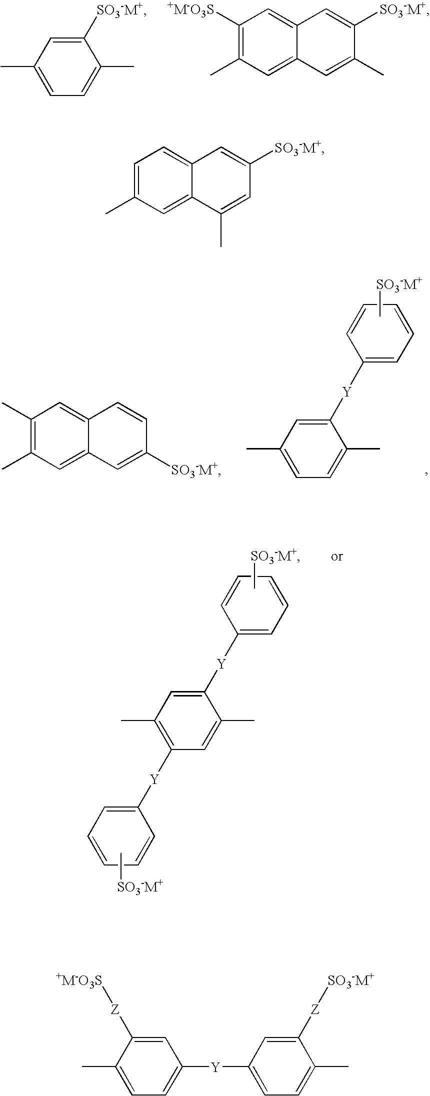

Moreover, Ar represents a non-sulfonated aromatic group, such as

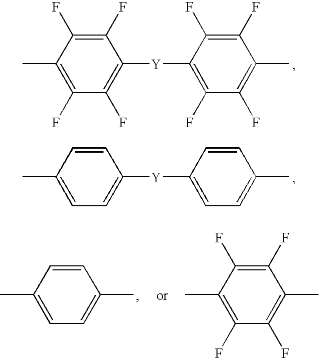

In the above structural formulas representing examples of SAr1 and Ar, Y represents a carbon-carbon single bond

such as

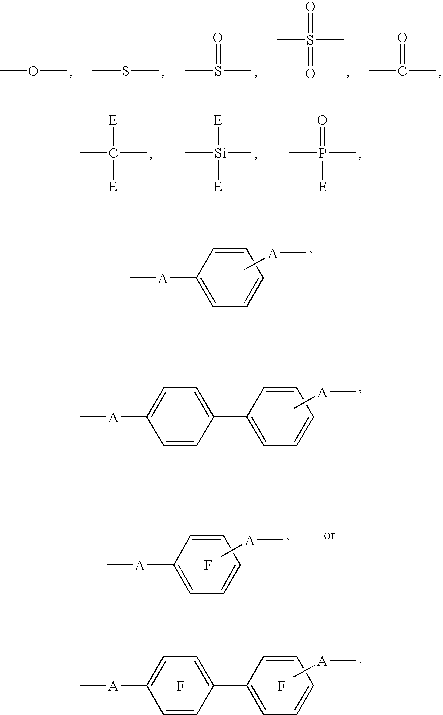

A represents a carbon-carbon single bond such as

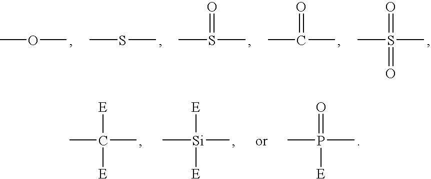

E represents H, F, C1-C5 or number

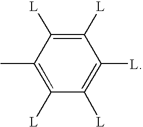

### Moreover, in Y,

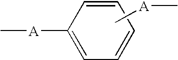

represents a benzene structure that may be situated in the ortho, meta or para position, and

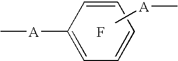

represents a benzene structure, in which a fluorine (F) is completely substituted, that may be situated in the ortho, meta or para positions. That is,

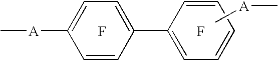

represents benzene structures in which fluorines (F) are completely substituted, that may be situated in the

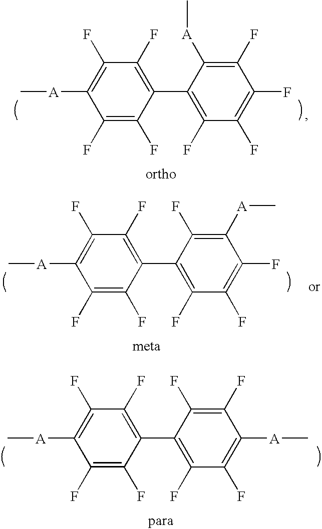

position. Moreover, E represents H, F, C1-C5, or

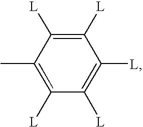

wherein H is hydrogen, F is fluorine, and C1-C5 is a hydrogen- or fluorine-substituted alkyl structure having 1 to 5 carbon atoms, and

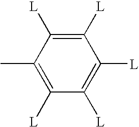

represents a benzene structure in which L is substituted in benzene. In the above structural formula, L represents H, F, or C1-C5, wherein H is hydrogen, F is fluorine, and C1-C5 is a hydrogen- or fluorine-substituted alkyl structure having 1 to 5 carbon atoms.

Moreover, Z represents a direct bond between a carbon atom of benzene and —SO3-M+ such as,

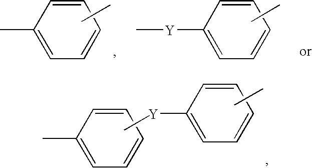

that may be situated in the ortho, meta, or para position, wherein Y is the same as described above. M+ represents a counterion having a cation ion such as a potassium ion (K+), a sodium ion (Na+), or an alkyl amine (+NR4), preferably, a potassium ion or a sodium ion. CM represents a crosslinkable moiety such as

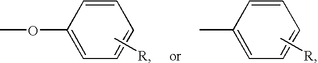

wherein R represents a triple bond (ethynyl part)

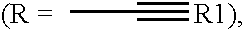

a double bond (vinyl part)

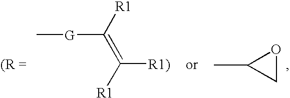

in which R1 is substituted, that may be situated in the ortho, meta, or para position. In the R, G represents a carbon-carbon single bond such as

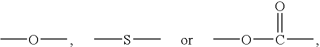

and R1 represents H, F, C1-C5, or,

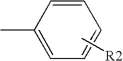

wherein H is hydrogen, F is fluorine, C1-C5 is a hydrogen- or fluorine-substituted alkyl structure having 1 to 5 carbon atoms, and R2 is a substituent having a benzene ring

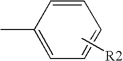

that may be substituted in the ortho, meta, or para position. R2 represents H, X or C1-C5, wherein H is hydrogen, X is a halogen atom such as F, Cl or Br, and C1-C5 is a hydrogen- or fluorine-substituted alkyl structure having 1 to 5 carbon atoms. X is also a functional group that may be polymerized with a hydroxy group of another polymer chain. Moreover, in Formula 1, k has a value in the range of 0.001 to 1.000, s has a value of (1−k), and (k+s)/m represents a value in the range of 0.800 to 1.200.

The sulfonated poly(arylene ether) copolymer containing a crosslinkable moiety at the ends of Formula 1 in accordance with Example 1 of the present invention is prepared by the following Scheme 1, and will be described in more detail as follow:

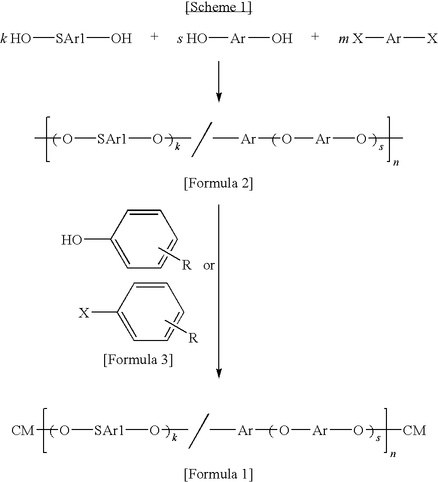

The above Scheme 1 is a reaction process for preparing a polymer of Formula 1, and a process for preparing the polymer of Formula 1 is a polycondensation reaction, in which the monomer participating in the reaction may be varied. In more detail, the sulfonated monomer (HO-SAr1-OH) used in the above Scheme 1 is a dihydroxy monomer.

It is possible to prepare a sulfonated poly(arylene ether) copolymer containing a crosslinkable moiety at the ends thereof through the above Scheme 1.

In Scheme 1, k has a value in the range of 0.001 to 1.000, s has a value of (1−k), and (k+s)/m represents a value in the range of 0.800 to 1.200. Moreover, k, s and m correspond to mole fractions of monomers participating in the reaction.

Here, the monomer in Formula 3 is a hydroxy-substituted monomer

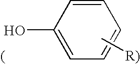

or a halide-substituted monomer

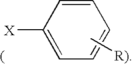

If (k+s)/m of Scheme 1 has a value of less than 1, the hydroxy-substituted monomer is used, whereas, if it has a value of more than 1, the halide-substituted monomer is used. If R2 of Formula 3 is X, the hydroxy-substituted monomer

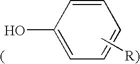

may be used in Formula 3, regardless of the value of (k+s)/m in Scheme 1.

The preparation process of the above Scheme 1 will be described as follow. First, a sulfonated dihydroxy monomer and a non-sulfonated dihydroxy monomer are activated. The activation process is to facilitate the polycondensation reaction of the dihydroxy monomer with the dihalide monomer. Moreover, the non-sulfonated dihalide monomer may be added in the same step as the dihydroxy monomer in the preparation process.

A polymer corresponding to the above Formula 2 is prepared by the polycondensation reaction in the temperature range of 0° C. to 300° C. for 1 to 100 hours in the presence of a solvent composed of a base, an azeotropic solvent and an aprotic polar solvent. Here, a protic polar solvent may be employed instead of the aprotic polar solvent according to the preparation process.

Subsequently, a polymer of crosslinkable moieties-substituted at the ends of Formula 1 is formed using the polymer of Formula 2 and the hydroxy-substituted monomer or the halide-substituted monomer of Formula 3.

The formation reaction of Formula 1 is carried out in the same manner of Formula 2. That is, a polymer of crosslinking moieties-substituted at the ends of Formula 1 is prepared using the activation and polycondensation reaction steps. Moreover, a step of removing the azeotropic solvent may be added prior to the polycondensation step after the activation step.

Furthermore, in this Example, the sulfonated poly(arylene ether) copolymer containing a crosslinkable moiety at the ends of Formula 1 in accordance with the present invention is prepared by substituting a crosslinking moiety (CM) containing a crosslinking group at the ends of a polymer chain by the polycondensation reaction for the improvement of thermal stability, electrochemical properties, film formability, dimensional stability, mechanical stability, chemical properties, physical properties, cell performance, and the like of the polymer represented by Formula 2.

In the polycondensation reaction and the crosslinking group introduction reaction for the synthesis of the sulfonated poly(arylene ether) copolymer containing a crosslinkable moiety at the ends of Formula 1 in accordance with the present invention, an inorganic base selected from the group consisting of an alkali metal, a hydroxide of an alkaline earth metal, a carbonate and a sulfate, or an organic base selected from the group consisting of ordinary amines including ammonia may be used as a base.

Moreover, an aprotic polar solvent or a protic polar solvent may be used as the reaction solvent. As the aprotic polar solvent, N-methylpyrrolidone (NMP), dimethylformamide (DMF), N,N-dimethylacetamide (DMAc), dimethylsulfoxide (DMSO), and the like may used. As the protic polar solvent, methylene chloride (CH₂Cl₂), chloroform (CH₃Cl), tetrahydrofuran (THF), and the like may be used. As the azeotropic solvent, benzene, toluene, xylene, and the like may be use.

The sulfonated poly(arylene ether) copolymer containing a crosslinkable moiety at the ends thereof prepared in the method as described above maintained the equivalent or superior levels to existing sulfonated poly(arylene ether) copolymers or the Nafion membrane used commercially as a polymer electrolyte membrane in terms of thermal stability, film formability, mechanical stability, chemical properties, mechanical properties, cell performances, and the like and, at the same time, showed highly improved electrochemical properties, particularly, proton conductivity and cell performances. Moreover, even though it was exposed to water for a long time, there was no change in electrolyte membrane properties, thus showing a high dimensional stability.

The present invention will be described in more detail based on the following Preparation Examples; however, the present invention is not limited thereto.

### Preparation Example 1

### Preparation of Sulfonated Poly(Arylene Ether) Copolymer (SPAE-HQ)

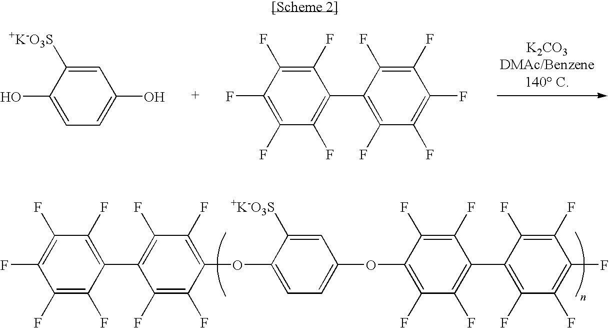

3 g of hydroquinonesulfonic acid potassium salt (13.1423 mmol), 2.15 g of K₂CO₃, 50 ml of N,N-dimethylacetamide (DMAc), and 25 ml of benzene were added in a 100 ml 2-necked round bottom flask equipped with a stirrer, a nitrogen inlet tube, a magnetic stir bar, and a Dean-Stark trap (azeotropic distillation).

The activation step was carried out in the temperature range of 135° C. to 140° C. for 6 to 8 hours. Water formed as a by-product during the reaction was removed by azeotropic distillation with benzene, one of the reaction solvents, and the benzene was removed from the reactor after the completion of the activation step.

Subsequently, after adding 4.4 g of decafluorobiphenyl (13.1693 mmol) to the reactor, the reaction continued at the temperature of 140° C. for over 12 hours. After the reaction, the resulting solution was precipitated in 500 ml of ethanol, washed with water and ethanol several times and then dried in vacuum at 60° C. for 3 days to yield the title copolymer as a light brown solid in a yield of more than 90%.

The structure of the SPAE-HQ polymer synthesized in the above-described manner was analyzed by ¹H-NMR and ¹⁹F-NMR.

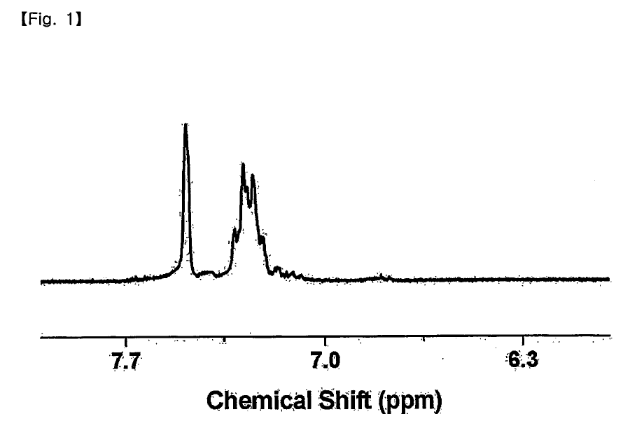

As a result of ¹H-NMR analysis of FIG. 1, it can be seen that there is no hydroxy group peak of a monomer. Moreover, peaks are shown at 7.51 ppm, 7.32 ppm and 7.28 ppm corresponding to the polymer peaks. Furthermore, as a result of ¹⁹F-NMR analysis, it can be seen from the only two peaks shown that F in the para position of a decafluorobiphenyl group was separated by participating in the polymerization reaction.

### Preparation Example 2

### Preparation of Polymer Electrolyte Membrane Using SPAE-HQ

The sulfonated poly(arylene ether) copolymer (SPAE-HQ) prepared in Preparation Example 1 was dissolved in a solvent and filtered using 0.45 μm PTFE membrane filter. Then, the resulting polymer solvent was poured on a glass plate by casting and kept in an oven at 40° C. for 24 hours. Then, the resulting glass plate supporting the polymer membrane was kept in a vacuum oven at 70° C. for 24 hours to completely remove the solvent. The solvent used was a dipolar solvent and, in more detail, N,N′-dimethylformamide (DMF), dimethylacetamide (DMAc), dimethylsulfoxide (DMSO), or N-methylpyrrolidone (NMP) may be used.

After the completion of the heat treatment, the resulting polymer was cooled to room temperature, and a salt ion (Na⁺, K⁺, or alkyl ammonium ion) in the sulfone portion of the polymer prepared in Scheme 2 was substituted with hydrogen through an acid treatment. The acid treatment was carried out in such a manner that the resulting polymer was immersed in a sulfuric acid (H₂SO₄) solution of 2 normal concentration, a nitric acid (HNO₃) solution of 1 normal concentration, or a hydrochloric acid (HCl) solution of 1 normal concentration for 24 hours and, then, immersed again in distilled water for 24 hours, or boiled in a sulfuric acid (H₂SO₄) solution of 0.5 molar concentration for 2 hours; however, the acid treatment process is not limited thereto. After immersing the acid-treated polymer electrolyte membrane in distilled water for 24 hours, proton conductivity was measured.

The measured solubility of the polymer electrolyte membrane (SPAE-HQ) prepared in Preparation Example 2 is shown in the following table 1:

TABLE 1

| Polymer | NMP^{b} | DMAc^{c} | DMSO^{d} | DMF^{e} | THF^{f} | Acetone | CHCl₃ | MeOH^{g} | water |
|---|---|---|---|---|---|---|---|---|---|
| SPAE-HQ^{a} | S | S | S | S | P | P | Sw | S | I |

^{a}Polymer electrolyte membrane prepared in Preparation Example 2
^{b}NMP (N-methylpyrrolidone)
^{c}DMAc (N,N-dimethylacetamide)
^{d}DMSO (dimethylsulfoxide)
^{e}DMF (dimethylformamide)
^{f}THF (tetrahydrofuran)
^{g}MeOH (methanol)
S = Soluble at room temperature
P = Partially soluble at room temperature
I = Insoluble at room temperature
Sw = Swelling at room temperature

It can be seen from table 1 that the polymer electrolyte membrane is influenced by other solvents to some extent but not dissolved in water. That is, the polymer electrolyte membrane prepared in Preparation Example 2 has a high dimensional stability to water and is suitable for a polymer electrolyte membrane fuel cell (PEMFC) using hydrogen as a fuel in various fuel cells.

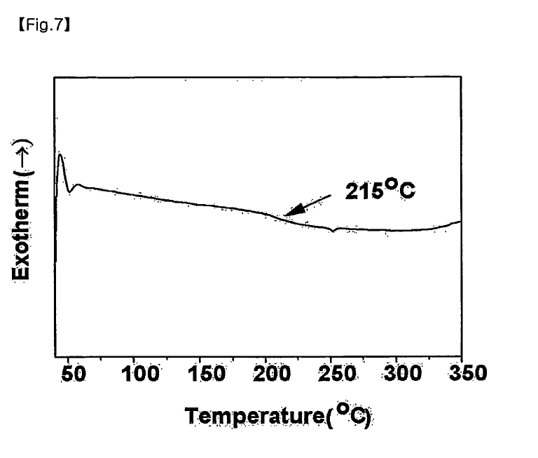

Moreover, glass transition temperature (Tg) of the polymer electrolyte membrane prepared in Preparation Example 2 was measured by differential scanning calorimetry (DSC) under a nitrogen atmosphere at 10° C./min. The result was 215° C. which was the same as the polymer of E-SPAE-HQ before being crosslinked as shown in FIG. 7. Accordingly, it can be seen that the polymer electrolyte membrane prepared in Preparation Example 2 has a thermal stability higher than the Nafion 117 membrane commercially available at present.

The water uptake and proton conductivity of the polymer electrolyte membrane prepared in Preparation Example 2 were compared with those of the Nafion 117 membrane commercially available at present and shown in the following table 2:

TABLE 2

| | Ion Exchange | | | |
|---|---|---|---|---|
| | Capability (meq/g) | | Ionic | Water |
| Electrolyte | Calculated | Measured | Conductivity | Uptake |
| Membrane | Value^{a} | Value^{b} | (S/cm)^{c} | (wt %)^{d} |
| SPAE-HQ | 2.065 | 2.279 | 0.164 | 78 |
| Nafion 117 | 0.91 | 0.91 | 0.083 | 20 |

^{a}calculated from the molar fraction of monomer [IEC = (1000/repeating unit molecular weight) × sulfonated ratio × number of sulfonic groups]
^{b}measured by titrating with 0.01 N NaOH solution using phenolphthalein as an indicator after immersing in 0.01N NaCl solution for 24 hours
^{c}equivalent per equivalent of the sulfonic acid group
^{d}measured using an impedance analyzer (AutoLab, PGSTAT 30, Netherlands) [σ(S cm⁻¹) = L/(R × S), wherein L (cm) is a distance between two electrodes, R(Ω) is membrane resistance, and S (cm²) is the surface area of ions passing through the membrane]
e: calculated value of membrane weight [water uptake (%) = (Wwet − Wdry) × 100/Wdry, wherein Wwet is the weight of wet membrane, and Wdry is the weight of dried membrane

As can be seen from table 2, the proton conductivity that is one of the most important properties of the polymer electrolyte membrane is nearly two times higher than that of the Nafion 117 membrane.

### Preparation Example 3

### Preparation of Sulfonated Poly(Arylene Ether) Copolymer Containing a Crosslinkable Moiety at the Ends Thereof (E-SPAE-HQ)

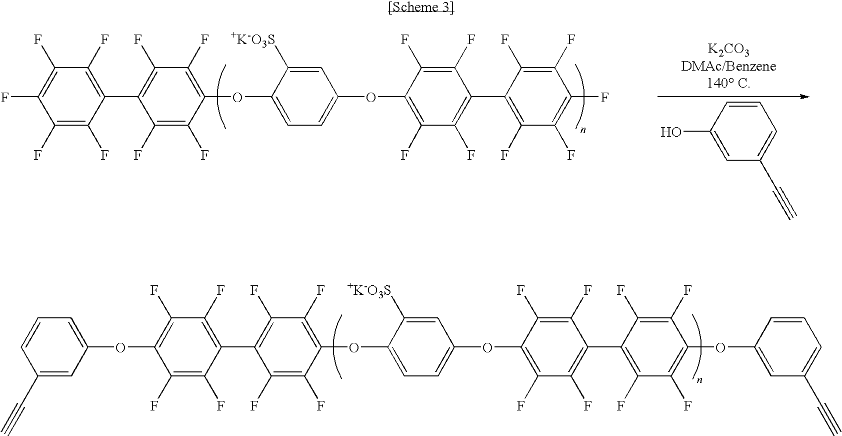

The title E-SPAE-HQ was prepared by introducing a 3-ethynylphenol into the ends of the polymer SPAE-HQ synthesized in Preparation Example 1.

That is, 3-ethynylphenol in an amount corresponding to 0.2 to 0.5 times molar ratio of decafluorobiphenyl monomer, 20 ml of benzene and 0.7 g of K₂CO₃ were added in a polymer solution synthesized in Preparation Example 1 and subjected to an addition reaction at 140° C. for more than 6 hours. Then, the benzene was completely removed. Moreover, water formed as a by-product during the reaction was removed by azeotropic distillation with benzene.

After the completion of the reaction, the resulting polymer was precipitated in 500 ml of ethanol, washed with water and ethanol several times and then dried in vacuum at 60° C. for 3 days to yield the title copolymer as a light brown solid in a yield of more than 90%.

The structure of the E-SPAE-HQ polymer synthesized in the above-described manner was analyzed by ¹H-NMR, ¹⁹F-NMR and IR.

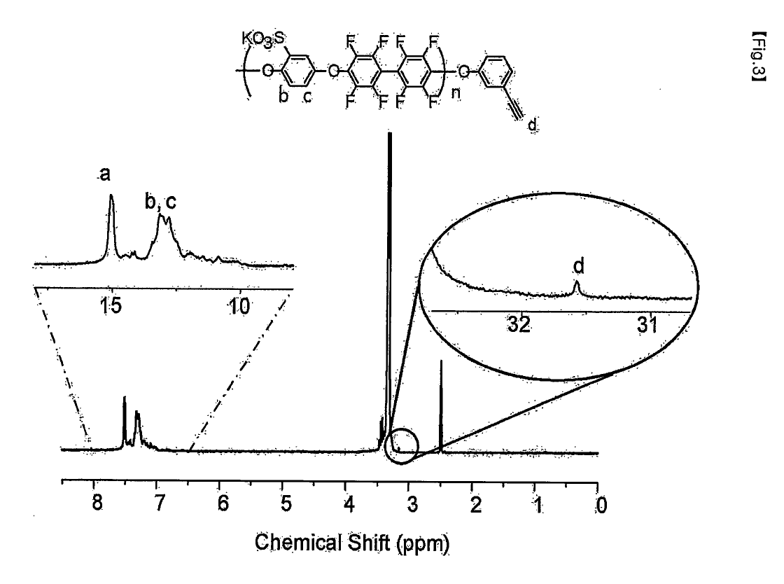

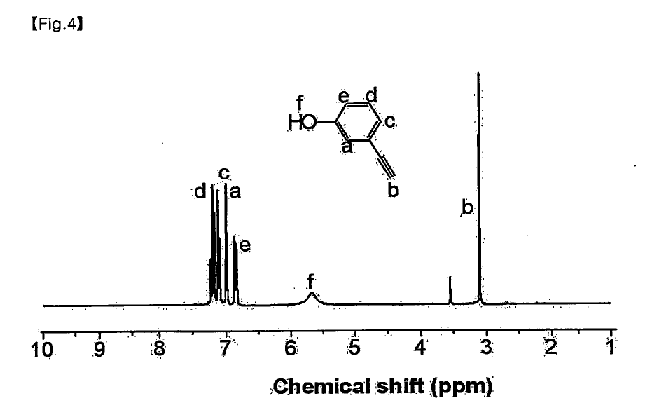

As a result of ¹H-NMR analysis of FIG. 3, it can be seen that there is no hydroxy group peak of a monomer. Moreover, peaks are shown at 7.51 ppm, 7.32 ppm and 7.28 ppm corresponding to the polymer peaks. Moreover, as the hydrogen peak of ethynyl is shown at 3.16 ppm, it can be ascertained that the ethynyl group is substituted as can be seen from ¹H-NMR of the ethynylphenol monomer in FIG. 4.

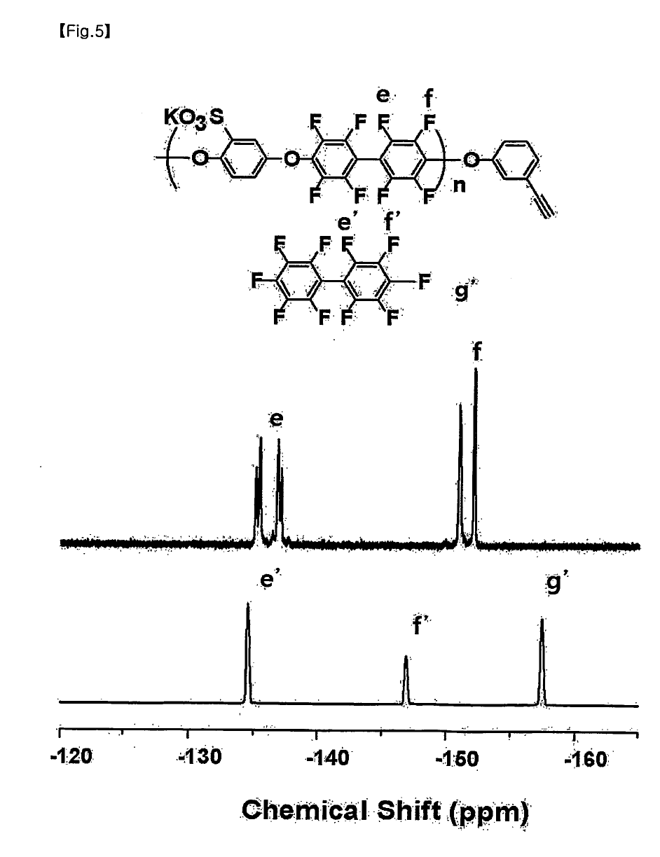

As a result of ¹⁹F-NMR analysis of FIG. 5, it can be seen from the only two peaks shown that F in the para position of a decafluorobiphenyl group was separated by participating in the polymerization reaction.

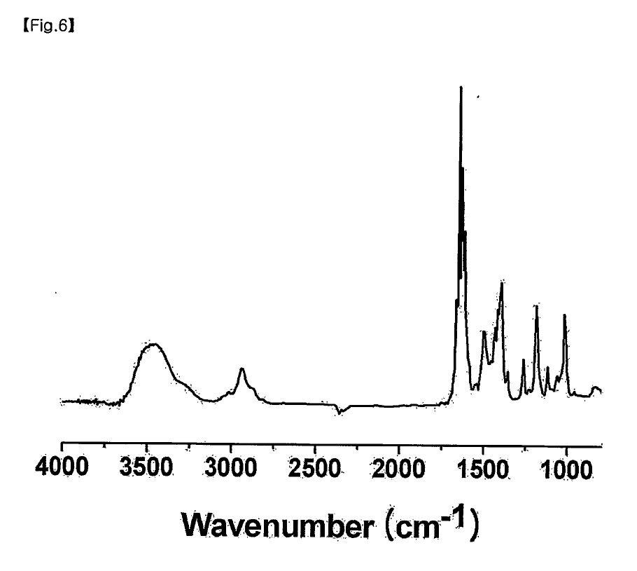

As a result of IR analysis of FIG. 6, it can be ascertained from the peak shown in the vicinity of 2900 cm⁻¹ that the ethynyl group at the end of the polymer is substituted.

Moreover, glass transition temperature (Tg) was measured by differential scanning calorimetry (DSC) of FIG. 7 under a nitrogen atmosphere at 10° C./min. The measured glass transition temperature of the polymer of E-SPAE-HQ before being crosslinked was 215° C. Accordingly, it can be seen that the polymer electrolyte membrane prepared in Preparation Example 3 has a thermal stability higher than the Nafion 117 membrane commercially available at present.

The measured solubility of the polymer electrolyte membrane (E-SPAE-HQ) prepared in Preparation Example 3 is shown in the following table 3. Solubility was measured after immersing the polymer in a solvent at room temperature for 24 hours.

TABLE 3

| Polymer | NMP^{b} | DMAc^{c} | DMSO^{d} | DMF^{e} | THF^{f} | Acetone | CHCl₃ | MeOH^{g} | water |
|---|---|---|---|---|---|---|---|---|---|
| E-SPAE-HQ^{a} | S | S | S | S | I | I | I | I | Sw |

^{a}Vacuum dried polymer after the polymerization carried out in Preparation Example 3
^{b}NMP (N-methylpyrrolidone)
^{c}DMAc (N,N-dimethylacetamide)
^{d}DMSO (dimethylsulfoxide)
^{e}DMF (dimethylformamide)
^{f}THF (tetrahydrofuran)
^{g}MeOH (methanol)
S = Soluble at room temperature
P = Partially soluble at room temperature
I = Insoluble at room temperature
Sw = Swelling at room temperature

### Preparation Example 4

### Preparation of Polymer Electrolyte Membrane (CSPAE-HQ)

The sulfonated poly(arylene ether) copolymer containing a crosslinkable moiety at the ends thereof (E-SPAE-HQ) prepared in Preparation Example 3 was dissolved in a solvent and filtered using 0.45 μm PTFE membrane filter. Then, the resulting polymer solvent was poured on a glass plate by casting and kept in an oven at 40° C. for 24 hours. Then, the resulting glass plate supporting the polymer membrane was kept in a vacuum oven at 70° C. for 24 hours to carry out a heat treatment for more than 20 minutes at a temperature in the vicinity of 200° C. Subsequently, the heat-treated glass plate was subjected to a heat treatment in the temperature range of 250° C. to 260° C. to crosslink the ends of the polymer. The solvent used was a dipolar solvent and, in more detail, N,N′-dimethylformamide (DMF), dimethylacetamide (DMAc), dimethylsulfoxide (DMSO), or N-methylpyrrolidone (NMP) may be used.

After the completion of the heat treatment, the resulting polymer was cooled to room temperature, and a salt ion (Na⁺, K⁺, or alkyl ammonium ion) in the sulfone portion of the polymer prepared in Scheme 3 was substituted with hydrogen through an acid treatment. The acid treatment was carried out in such a manner that the resulting polymer was immersed in a sulfuric acid (H₂SO₄) solution of 2 normal concentration, a nitric acid (HNO₃) solution of 1 normal concentration, or a hydrochloric acid (HCl) solution of 1 normal concentration for 24 hours and, then, immersed again in distilled water for 24 hours, or boiled in a sulfuric acid (H₂SO₄) solution of 0.5 molar concentration for 2 hours; however, the acid treatment process is not limited thereto. After immersing the acid-treated polymer electrolyte membrane in distilled water for 24 hours, proton conductivity was measured.

The measured solubility of the polymer electrolyte membrane (CSPAE-HQ) prepared in Preparation Example 4 is shown in the following table 4:

TABLE 4

| Polymer | NMP^{b} | DMAc^{c} | DMSO^{d} | DMF^{e} | THF^{f} | Acetone | CHCl₃ | MeOH^{g} | water |
|---|---|---|---|---|---|---|---|---|---|
| CSPAE-HQ^{a} | I | I | I | I | I | I | I | I | I |

^{a}Polymer electrolyte membrane prepared in Preparation Example 4
^{b}NMP (N-methylpyrrolidone)
^{c}DMAc (N,N-dimethylacetamide)
^{d}DMSO (dimethylsulfoxide)
^{e}DMF (dimethylformamide)
^{f}THF (tetrahydrofuran)
^{g}MeOH (methanol)
S = Soluble at room temperature
P = Partially soluble at room temperature
I = Insoluble at room temperature
Sw = Swelling at room temperature

It can be seen from table 4 that the polymer electrolyte membrane is crosslinked as it was not dissolved in any solvent, and the polymer electrolyte membrane is very stable chemically and has a high dimensional stability.

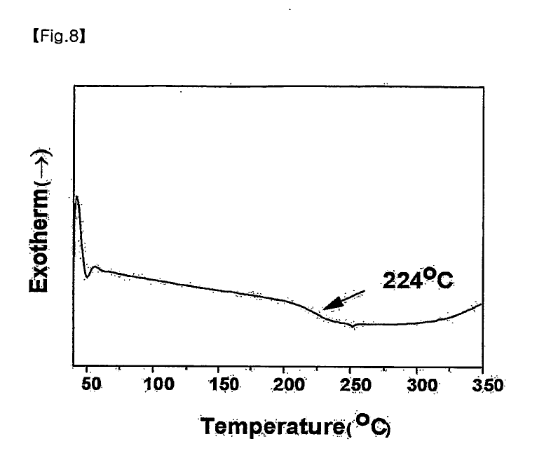

Moreover, glass transition temperature (Tg) of the polymer electrolyte membrane prepared in Preparation Example 4 was measured by differential scanning calorimetry (DSC) under a nitrogen atmosphere at 10° C./min. As shown in FIG. 8, the result was 224° C., and the thermal stability of the polymer electrolyte membrane (CSPAE-HQ) was improved more than that of the polymer before being crosslinked. Moreover, it can be ascertained that the polymer electrolyte membrane prepared in Preparation Example 4 has a thermal stability considerably higher than the Nafion 117 membrane commercially available at present.

The water uptake and proton conductivity of the polymer electrolyte membrane prepared in Preparation Example 4 were compared with those of the Nafion 117 membrane commercially available at present and shown in the following table 5:

TABLE 5

| | Ion Exchange | | | |
|---|---|---|---|---|
| | Capability (meq/g) | | Ionic | Water |
| Electrolyte | Calculated | Measured | Conductivity | Uptake |
| Membrane | Value^{a} | Value^{b} | (S/cm)^{c} | (wt %)^{d} |
| CSPAE-HQ | 2.065 | 2.123 | 0.141 | 52 |
| Nafion 117 | 0.91 | 0.91 | 0.083 | 20 |

^{a}calculated from the molar fraction of monomer [IEC = (1000/repeating unit molecular weight) × sulfonated ratio × number of sulfonic groups]
^{b}measured by titrating with 0.01 N NaOH solution using phenolphthalein as an indicator after immersing in 0.01N NaCl solution for 24 hours
^{c}equivalent per equivalent of the sulfonic acid group
^{d}measured using an impedance analyzer (AutoLab, PGSTAT 30, Netherlands) [σ(S cm⁻¹) = L/(R × S), wherein L (cm) is a distance between two electrodes, R(Ω) is membrane resistance, and S (cm²) is the surface area of ions passing through the membrane]
e: calculated value of membrane weight [water uptake (%) = (Wwet − Wdry) × 100/Wdry, wherein Wwet is the weight of wet membrane, and Wdry is the weight of dried membrane

As can be seen from table 5, the proton conductivity that is one of the most important properties of the polymer electrolyte membrane is nearly two times higher than that of the Nafion 117 membrane.

Moreover, oxidation stability was measured using Fenton's reagent at 80° C. The Fenton's reagent used was 3% hydrogen peroxide solution containing 2 ppm of iron sulfate (FeSO₄). As a result of the measurement using the Fenton's reagent, there was no change in the membrane for 4 hours. After the lapse of 4 hours, the membrane started to be dissolved to some degree and completely dissolved after the lapse of 7 hours. That is, the crosslinked polymer electrolyte membrane was not dissolved for a longer time than the non-crosslinked sulfonated poly(arylene ether) copolymer or sulfonated polyimide.

Furthermore, methanol permeability was measured in order to examine how readily methanol permeates through the polymer electrolyte membrane for the application to the direct methanol fuel cell (DMFC). The measured values were shown as 1.4×10⁻⁶ cm²s⁻¹ in the Nafion 117 membrane, and as 0.6×10⁻⁶ cm²s⁻¹ in the polymer electrolyte membrane prepared in Preparation Example 4, from which it can be understood that the methanol permeation was made less than the Nafion 117 membrane and thereby the fuel loss was reduced.

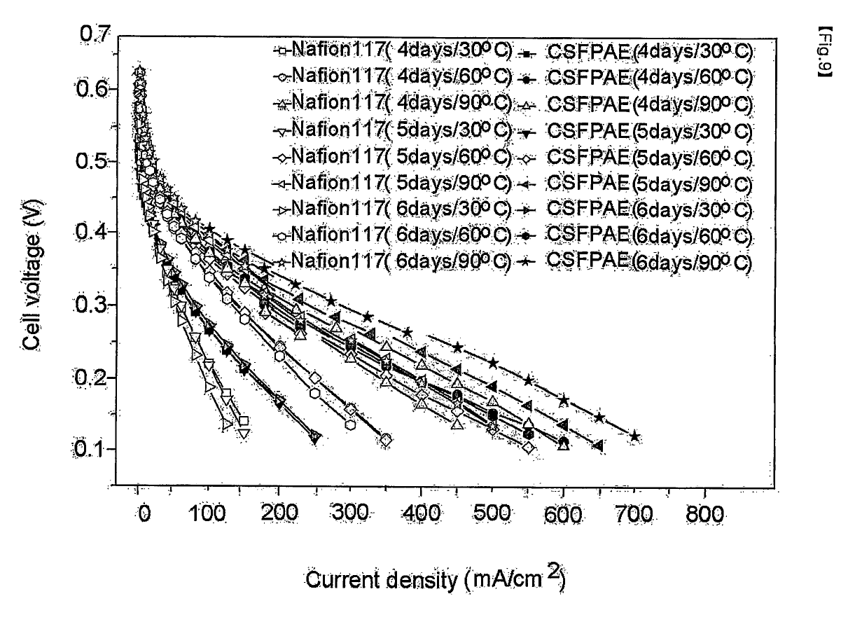

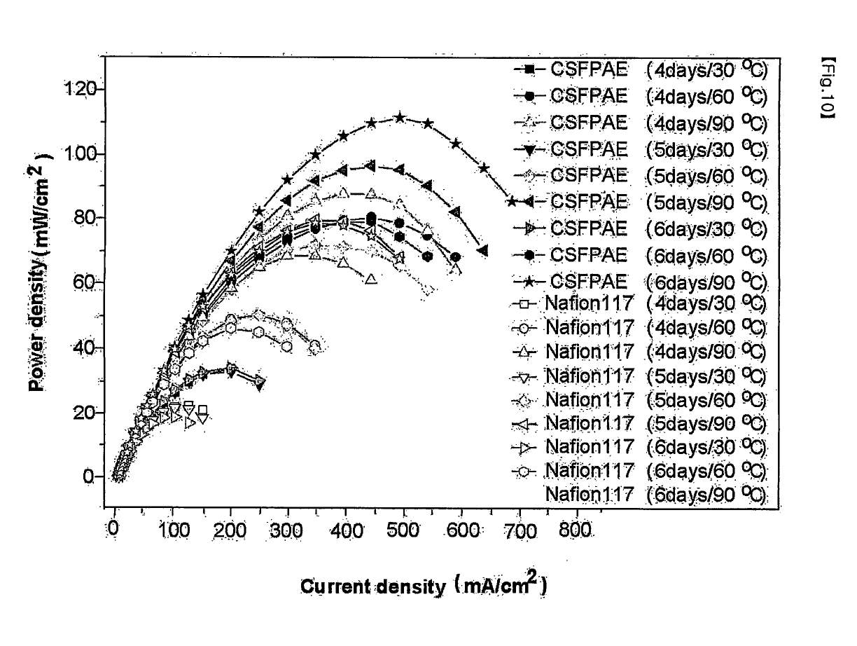

Moreover, as shown in FIGS. 9 and 10, the polymer electrolyte membrane prepared in Preparation Example 4 was applied to a unit cell of the direct methanol fuel cell (DMFC) in order to measure cell performances under the same conditions as the Nafion 117 membrane.

The measurement of DMFC performance was carried out by changing the temperature regularly for 10 days. In more detail, for the first couple of days, the DMFC was operated at room temperature without change in temperature and, from the third day, operated at 30° C. for 3 hours, at 60° C. for 3 hours, at 90° C. for 3 hours, and at room temperature for the rest 15 hours. The DMFC was operated in the same manner for 8 days from the third day. There was no change in the performances from the seventh to tenth days. Here, as anode (oxidation electrode) conditions, PtRu catalyst was coated on a carbon paper at 3 mg/cm² and 2 M of methanol was fed to the anode at a flow rate of 1 ml/min. As cathode (reduction electrode) conditions, Pt catalyst was coated on a carbon paper at 4 mg/cm² and dry oxygen was fed to the cathode at a flow rate of 500 ml/min.

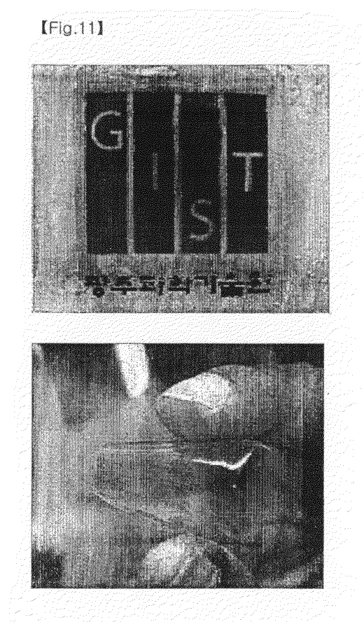

As shown in FIGS. 9 and 10, the polymer electrolyte membrane prepared in Preparation Example 4 showed unit cell performances significantly higher than those of the Nafion 117 membrane in terms of the polarization curve and the power density at the same temperatures. Moreover, as can be seen from FIG. 11, the polymer electrode membrane was very transparent and flexible and showed excellent film formability.

### Preparation Example 5

### Preparation of Sulfonated Poly(Arylene Ether)-NP Copolymer (SPAE-NP)

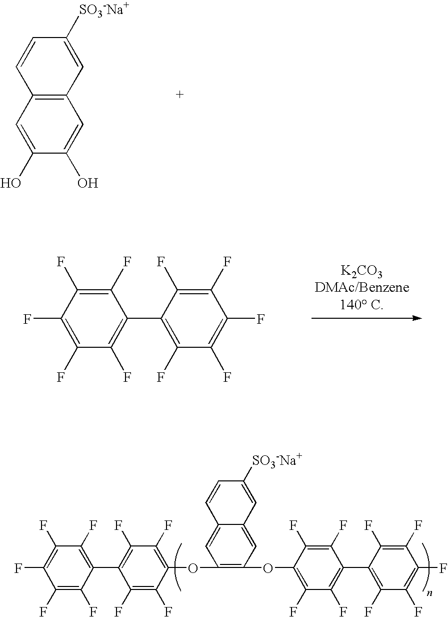

SPAE-NP was prepared in the same manner as Preparation Example 1, except that 2,3-dihydroxynaphthalene-6-sulfonic acid monosodium salt was used as the sulfonated monomer. The yield of the final product was more than 90%.

### Preparation Example 6

### Preparation of Sulfonated Poly(Arylene Ether)-NP Copolymer Containing a Crosslinkable Moiety at the Ends Thereof (E-SPAE-NP)

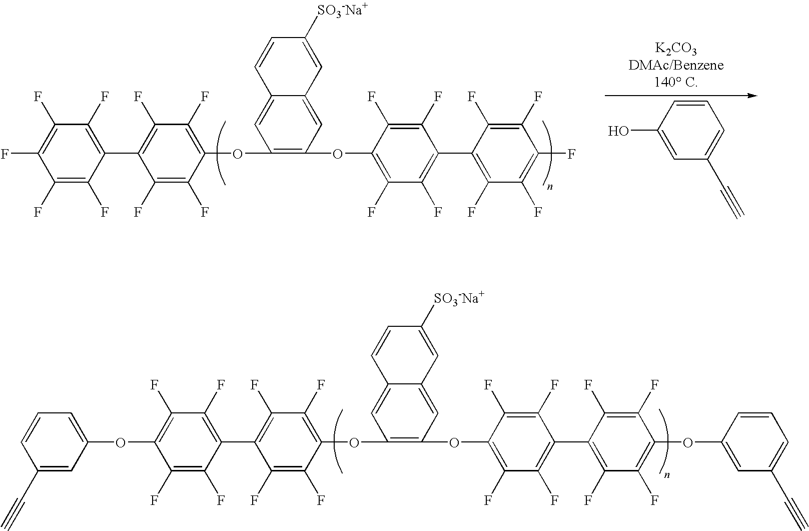

E-SPAE-NP was prepared in the same manner as Preparation Example 3, except that the SPAE-NP was used as the sulfonated polymer.

### Preparation Example 7

### Preparation of Sulfonated Poly(Arylene Ether)-mNP Copolymer (SPAE-mNP)

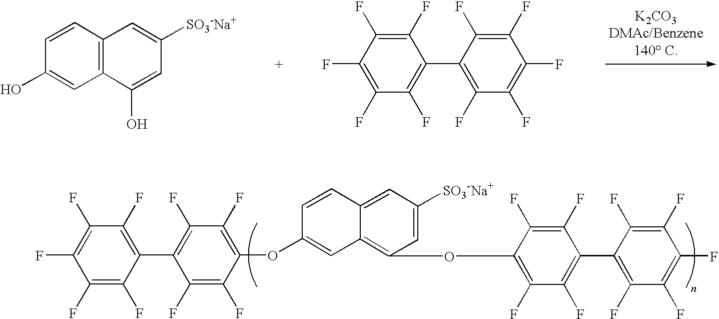

SPAE-mNP was prepared in the same manner as Preparation Example 1, except that 2,3-dihydroxynaphthalene-6-sulfonic acid monosodium salt was used as the sulfonated monomer. The yield of the final product was more than 90%.

### Preparation Example 8

### Preparation of Sulfonated Poly(Arylene Ether)-mNP Copolymer Containing a Crosslinkable Moiety at the Ends Thereof (E-SPAE-mNP)

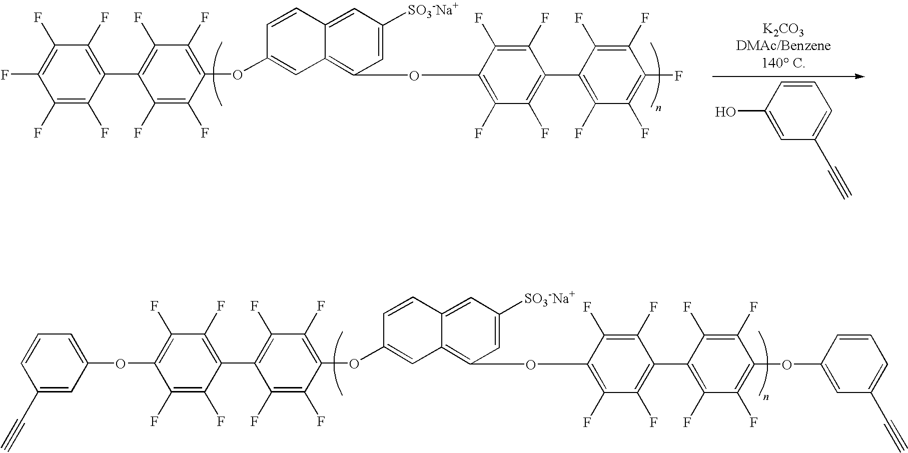

E-SPAE-mNP was prepared in the same manner as Preparation Example 3, except that the SPAE-mNP was used as the sulfonated polymer.

### Preparation Example 9

### Preparation of Sulfonated Poly(Arylene Ether)-dNP Copolymer (SPAE-dNP)

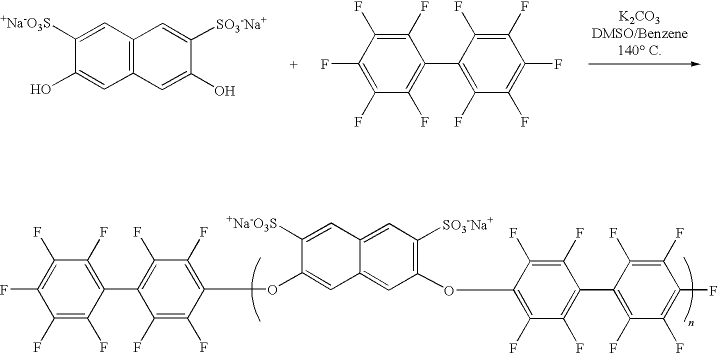

SPAE-dNP was prepared in the same manner as Preparation Example 1, except that 2,7-dihydroxynaphthalene-3,6-disulfonic acid disodium salt was used as the sulfonated monomer, and dimethylsulfoxide (DMSO) was used as the solvent instead of N,N-dimethylacetamide (DMAc). The yield of the final product was more than 80%.

### Preparation Example 10

### Preparation of Sulfonated Poly(Arylene Ether)-dNP Copolymer Containing a Crosslinkable Moiety at the Ends Thereof (E-SPAE-dNP)

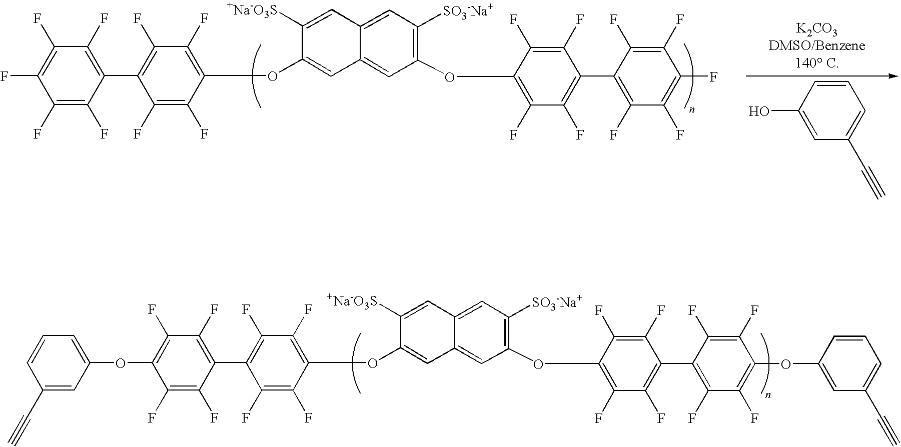

E-SPAE-dNP was prepared in the same manner as Preparation Example 3, except that the SPAE-dNP was used as the sulfonated polymer, and dimethylsulfoxide (DMSO) was used as the solvent instead of N,N-dimethylacetamide (DMAc).

### Preparation Example 11

### Preparation of Sulfonated Poly(Arylene Ether)-Sulfide-NP Copolymer (SPAE-SI-NP)

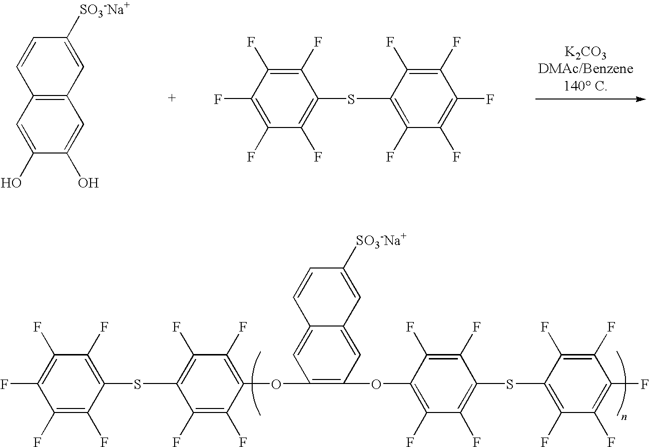

SPAE-SI-NP was prepared in the same manner as Preparation Example 1, except that 2,3-dihydroxynaphthalene-6-sulfonic acid monosodium salt was used as the sulfonated monomer, and pentafluorophenylsulfide was used as the dihalide monomer. The yield of the final product was more than 90%.

### Preparation Example 12

### Preparation of Sulfonated Poly(Arylene Ether)-Sulfide-NP Copolymer Containing a Crosslinkable Moiety at the Ends Thereof (E-SPAE-SI-NP)

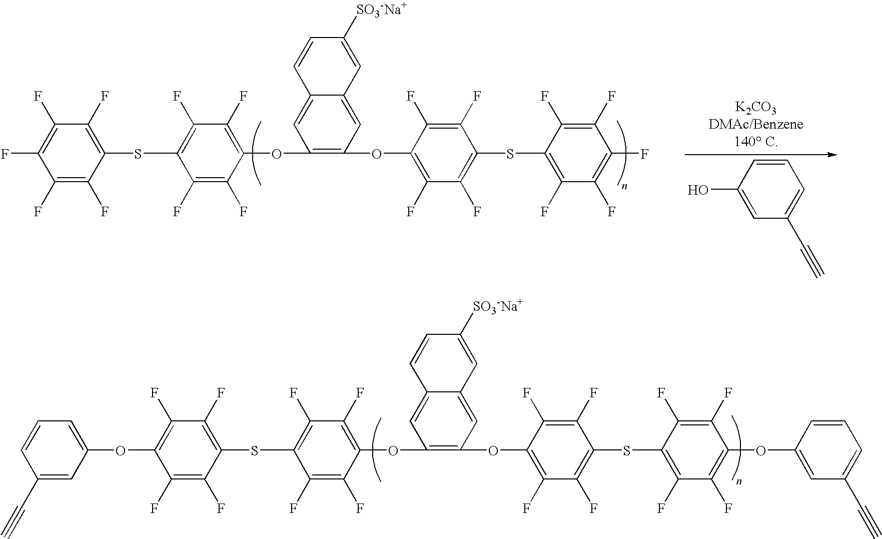

E-SPAE-SI-NP was prepared in the same manner as Preparation Example 3, except that the SPAE-SI-NP was used as the sulfonated polymer.

### Example 2

A sulfonated poly(arylene ether) copolymer in accordance with Example 2 of the present invention has a crosslinkable moiety at the ends thereof. The sulfonated poly(arylene ether) copolymer is represented by the following Formula 4:

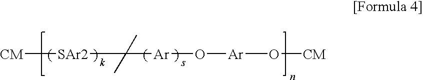

wherein SAr2 represents a sulfonated aromatic group such as

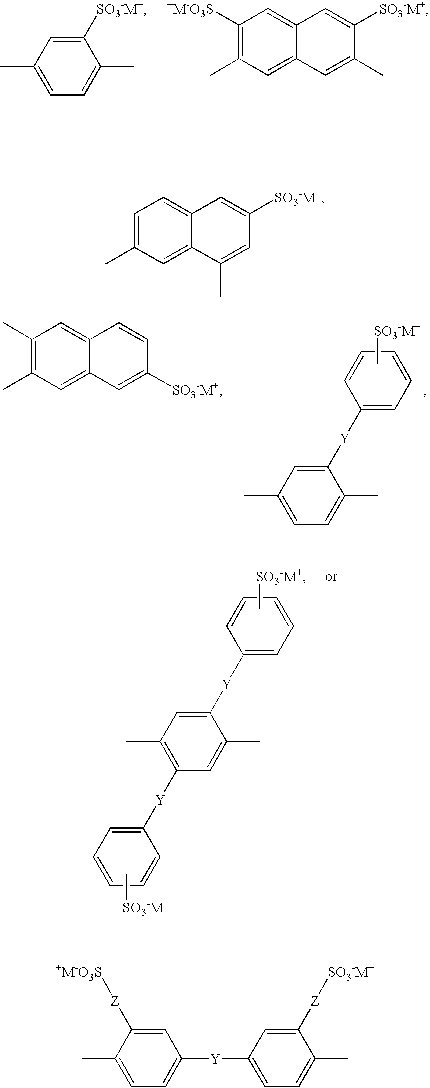

Moreover, Ar represents a non-sulfonated aromatic group, such as

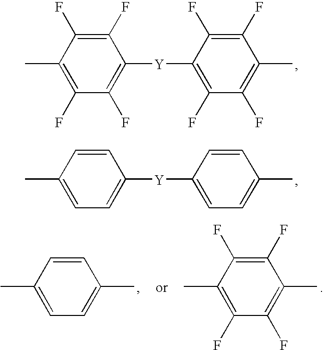

In the above structural formulas representing examples of SAr2 and Ar, Y represents a carbon-carbon single bond such as

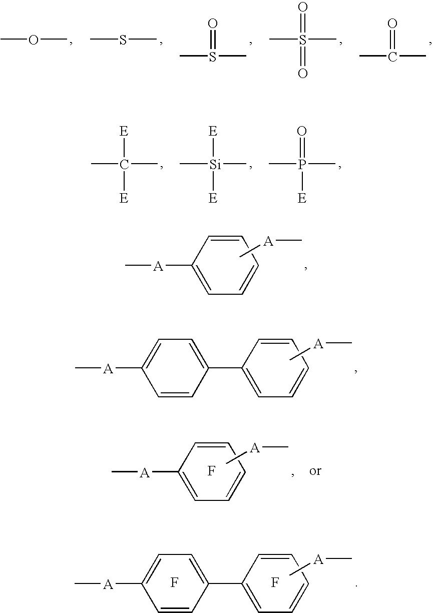

A represents a carbon-carbon single bond such as

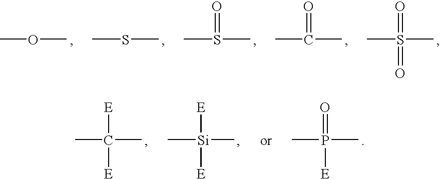

E represents H, F, C1-C5 or

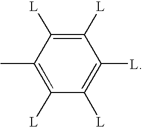

### Moreover, in Y,

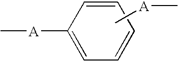

represents a benzene structure that may be situated in the ortho, meta or para position, and

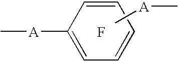

represents a benzene structure, in which a fluorine (F) is completely substituted, that may be situated in the ortho, meta or para positions. That is,

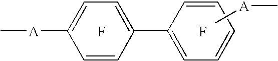

represents benzene structures in which fluorines (F) are completely substituted, that may be situated in the

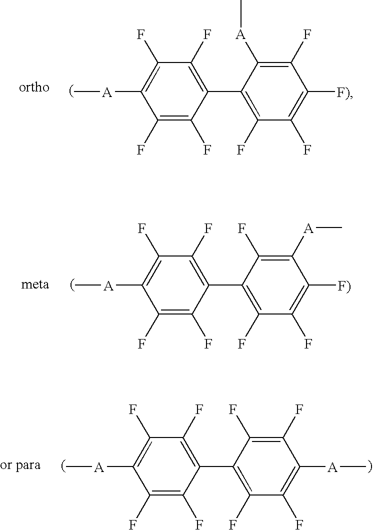

position. Moreover, E represents H, F, C1-C5, or

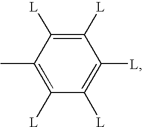

wherein H is hydrogen, F is fluorine, and C1-C5 is a hydrogen- or fluorine-substituted alkyl structure having 1 to 5 carbon atoms, and

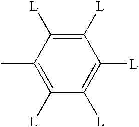

represents a benzene structure in which L is substituted in benzene. In the above structural formula, L represents H, F, or C1-C5, wherein H is hydrogen, F is fluorine, and C1-C5 is a hydrogen- or fluorine-substituted alkyl structure having 1 to 5 carbon atoms.

Moreover, Z represents a direct bond between a carbon atom of benzene and —SO3-M+ such as

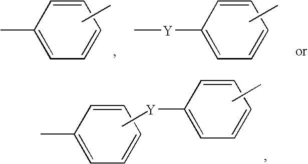

that may be situated in the ortho, meta, or para position, wherein Y is the same as described above. M+ represents a counterion having a cation ion such as a potassium ion (K+), a sodium ion (Na+), or an alkyl amine (+NR4), preferably, a potassium ion or a sodium ion. CM represents a crosslinkable moiety such as

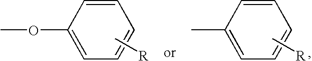

wherein R represents a triple bond (ethynyl part)

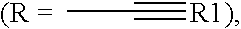

a double bond (vinyl part)

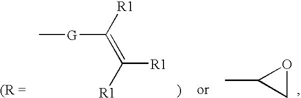

in which R1 is substituted, that may be situated in the ortho, meta, or para position. In the R, G represents a carbon-carbon single bond such as

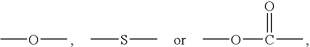

and R1 represents H, F, C1-C5,or,

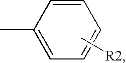

wherein H is hydrogen, F is fluorine, C1-C5 is a hydrogen- or fluorine-substituted alkyl structure having 1 to 5 carbon atoms, and R2 is a substituent having a benzene ring

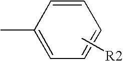

that may be substituted in the ortho, meta, or para position. R2 represents H, X or C1-C5, wherein H is hydrogen, X is a halogen atom such as F, Cl or Br, and C1-C5 is a hydrogen- or fluorine-substituted alkyl structure having 1 to 5 carbon atoms. X is also a functional group that may be polymerized with a hydroxy group of another polymer chain. Moreover, in Formula 1, k has a value in the range of 0.001 to 1.000, s has a value of (1−k), and (k+s)/m represents a value in the range of 0.800 to 1.200.

The sulfonated poly(arylene ether) copolymer containing a crosslinkable moiety at the ends of Formula 4 in accordance with Example 2 of the present invention is prepared by the following Scheme 4, and will be described in more detail as follow:

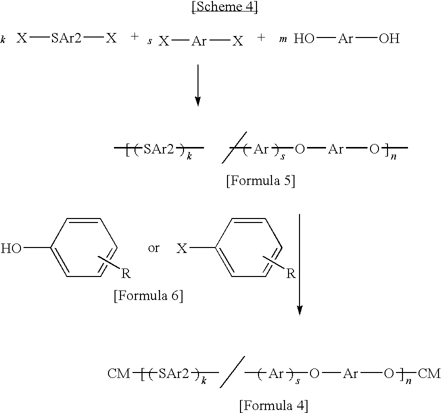

The above Scheme 4 is a reaction process for preparing a polymer of Formula 4, and the polymer of Formula 4 is prepared by a polycondensation reaction, in which the monomer participating in the reaction may be varied.

In more detail, the sulfonated monomer (X-SAr2-X) used in the above Scheme 4 is a dihalide monomer.

It is possible to prepare a sulfonated poly(arylene ether) copolymer containing a crosslinkable moiety at the ends thereof through the above Scheme 4.

In Scheme 4, k has a value in the range of 0.001 to 1.000, s has a value of (1−k), and (k+s)/m represents a value in the range of 0.800 to 1.200. Moreover, k, s and m correspond to mole fractions of monomers participating in the reaction.

Here, the monomer in Formula 6 is a hydroxy-substituted monomer

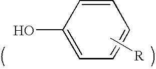

or a halide-substituted monomer

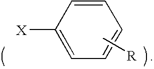

If (k+s)/m of Scheme 4 has a value of less than 1, the halide-substituted monomer

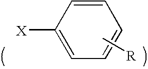

is used, whereas, if it has a value of more than 1, the hydroxy-substituted monomer

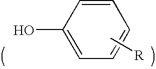

is used. If R2 of Formula 6 is X, the hydroxy-substituted monomer

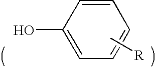

may be used in Formula 6, regardless of the value of (k+s)/m in Scheme 4.

The preparation process of the above Scheme 4 will be described as follow. First, a non-sulfonated dihydroxy monomer is activated. The activation process is to facilitate the polycondensation reaction of the dihydroxy monomer with the dihalide monomer. Moreover, the sulfonated dihalide monomer and the non-sulfonated dihalide monomer may be added in the same step as the dihydroxy monomer in the preparation process.

A polymer corresponding to the above Formula 5 is prepared by the polycondensation reaction in the temperature range of 0° C. to 300° C. for 1 to 100 hours in the presence of a solvent composed of a base, an azeotropic solvent and an aprotic polar solvent. Here, a protic polar solvent may be employed instead of the aprotic polar solvent according to the preparation process.

Subsequently, a polymer of crosslinkable moieties-substituted at the ends of Formula 4 is formed using the polymer of Formula 5 and the hydroxy-substituted monomer or the halide-substituted monomer of Formula 6.

The formation reaction of Formula 4 is carried out in the same manner of Formula 5. That is, a polymer of crosslinking moieties-substituted at the ends of Formula 4 is prepared using the activation and polycondensation reaction steps. Moreover, a step of removing the azeotropic solvent may be added prior to the polycondensation step after the activation step.

Furthermore, in this Example, the sulfonated poly(arylene ether) copolymer containing a crosslinkable moiety at the ends of Formula 4 in accordance with the present invention is prepared by substituting a crosslinking moiety (CM) containing a crosslinking group at the ends of a polymer chain by the polycondensation reaction for the improvement of thermal stability, electrochemical properties, film formability, dimensional stability, mechanical stability, chemical properties, physical properties, cell performance, and the like of the polymer represented by Formula 5.

In the polycondensation reaction and the crosslinking group introduction reaction for the synthesis of the sulfonated poly(arylene ether) copolymer containing a crosslinkable moiety at the ends of Formula 4 in accordance with the present invention, an inorganic base selected from the group consisting of an alkali metal, a hydroxide of an alkaline earth metal, a carbonate and a sulfate, or an organic base selected from the group consisting of ordinary amines including ammonia may be used as a base.

Moreover, an aprotic polar solvent or a protic polar solvent may be used as the reaction solvent. As the aprotic polar solvent, N-methylpyrrolidone (NMP), dimethylformamide (DMF), N,N-dimethylacetamide (DMAc), dimethylsulfoxide (DMSO), and the like may used. As the erotic polar solvent, methylene chloride (CH₂Cl₂), chloroform (CH₃Cl), tetrahydrofuran (THF), and the like may be used. As the azeotropic solvent, benzene, toluene, xylene, and the like may be use.

The sulfonated poly(arylene ether) copolymer containing a crosslinkable moiety at the ends thereof prepared in the method as described above maintained the equivalent or superior levels to existing sulfonated poly(arylene ether) copolymers or the Nafion membrane used commercially as a polymer electrolyte membrane in terms of thermal stability, film formability, mechanical stability, chemical properties, mechanical properties, cell performances, and the like and, at the same time, showed highly improved electrochemical properties, particularly, proton conductivity and cell performances. Moreover, even though it was exposed to water for a long time, there was no change in electrolyte membrane properties, thus showing a high dimensional stability.

The present invention will be described in more detail based on the following Preparation Examples; however, the present invention is not limited thereto.

### Preparation Example 13

### Preparation of Sulfonated Poly(Arylene Ether Sulfone)-FBA50 Copolymer (SPAESO-FBA50)

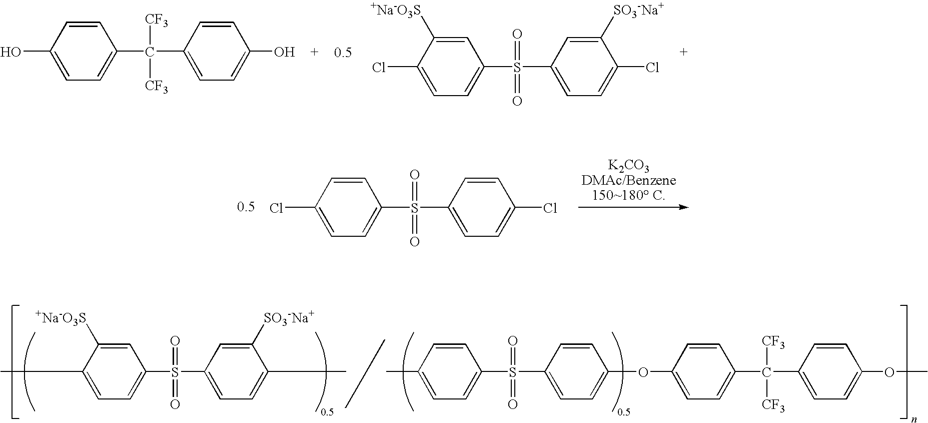

SPAESO-FBA50 was prepared in the same manner as Preparation Example 1, except that 0.5 mole fraction of dihalide monomer of 3,3′-disulfonated -4,4′-dichlorodiphenyl sulfone was used as the sulfonated monomer, and 0.5 mole fraction of dihalide monomer of 4,4′-dichlorodiphenyl sulfone and 1 mole fraction of dihydroxy monomer of 4,4′-(hexafluoroisopropylidene)diphenol were used as the non-sulfonated monomers. Moreover, the polymerization was carried out in the temperature range of 150° C. to 180° C. changed compared with that of Preparation Example 1. The yield of the final product was more than 87%.

### Preparation Example 14

### Preparation of Sulfonated Poly(Arylene Ether Sulfone)-FBA50 Copolymer Containing a Crosslinkable Moiety at the Ends Thereof (E-SPAESO-FBA50)

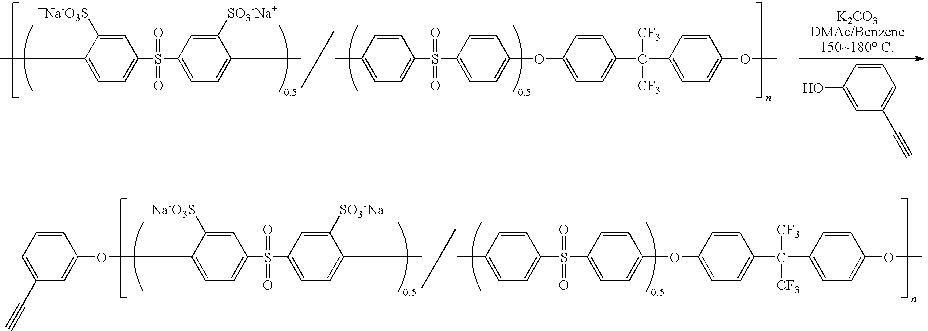

E-SPAESO-FBA50 was prepared in the same manner as Preparation Example 3, except that the SPAESO-FBA50 was used as the sulfonated polymer in the temperature range of 150° C. to 180° C.

### Preparation Example 15

### Preparation of Sulfonated Poly(Arylene Ether Ketone)-FBA50 Copolymer (SPAEK-FBA50)

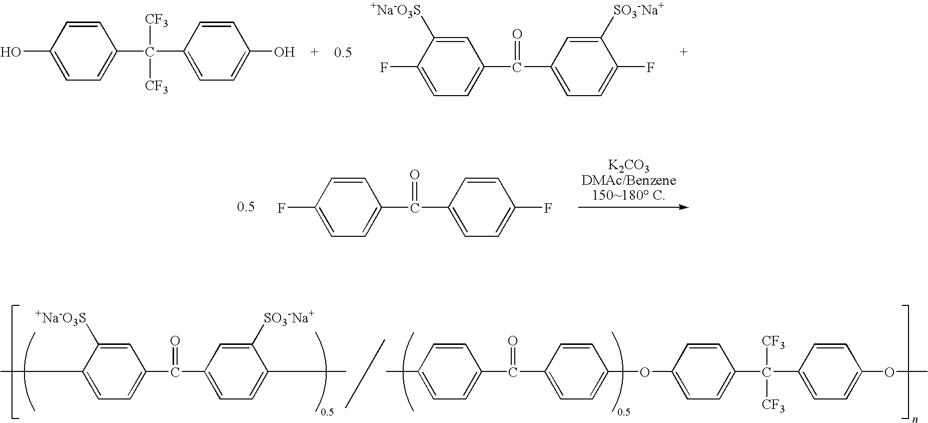

SPAEK-FBA50 was prepared in the same manner as Preparation Example 1, except that 0.5 mole fraction of dihalide monomer of 3,3′-disulfonated-4,4′-difluorobenzophenone was used as the sulfonated monomer, and 0.5 mole fraction of dihalide monomer of 4,4′-difluorobenzophenone and 1 mole fraction of dihydroxy monomer of 4,4′-(hexafluoroisopropylidene)diphenol were used as the non-sulfonated monomers. Moreover, the polymerization was carried out in the temperature range of 150° C. to 180° C. changed compared with that of Preparation Example 1. The yield of the final product was more than 93%.

### Preparation Example 16

### Preparation of Sulfonated Poly(Arylene Ether Ketone)-FBA50 Copolymer Containing a Crosslinkable Moiety at the Ends Thereof (E-SPAEK-FBA50)

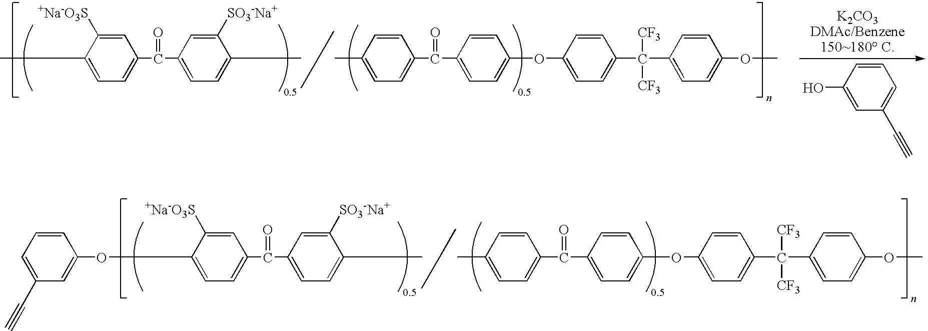

E-SPAEK-FBA50 was prepared in the same manner as Preparation Example 3, except that the SPAEK-FBA50 was used as the sulfonated polymer in the temperature range of 150° C. to 180° C.

As described above, it can be seen that the polymer electrolyte membranes prepared in accordance with the Examples of the present invention have high chemical and thermal stabilities. Moreover, it can be understood that the polymer electrolyte membranes prepared in accordance with the Examples of the present invention have a proton conductivity, one of the most important properties of the polymer electrolyte membrane, nearly two times higher than that of the Nafion 117 membrane commercially available at present.

### INDUSTRIAL APPLICABILITY

According to the present invention as described above, the polymer electrolyte membrane using the sulfonated poly(arylene ether) copolymer containing a crosslinkable moiety at the ends thereof maintains the equivalent or superior levels to existing polymer electrolyte membranes in terms of thermal stability, mechanical stability, chemical properties, film formability, and the like. Moreover, the polymer electrolyte membrane in accordance with the present invention shows considerably improved proton conductivity and cell performances compared with the existing polymer electrolyte membranes. Furthermore, even though it is exposed to water for a long time, there is no change in electrolyte membrane properties, thus showing a high dimensional stability. Accordingly, the polymer electrolyte membrane in accordance with the present invention can be effectively applied to a fuel cell, a secondary battery, and the like.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A sulfonated poly(arylene ether) copolymer containing a crosslinkable moiety at the ends thereof, represented by the following Formula 1: 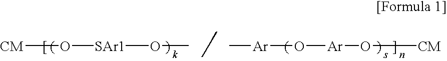
wherein SAr1 represents a sulfonated aromatic group, Ar represents a non-sulfonated aromatic group, CM represents a crosslinkable moiety, k has a value in the range of 0.001 to 1.000, s has a value of (1−k), and n represents an integer from 10 to 500 to represent a repeating unit of a polymer.

2. The copolymer of sulfonated poly(arylene ether) copolymer containing a crosslinkable moiety at the ends thereof as recited in claim 1,
wherein the SAr1 represents 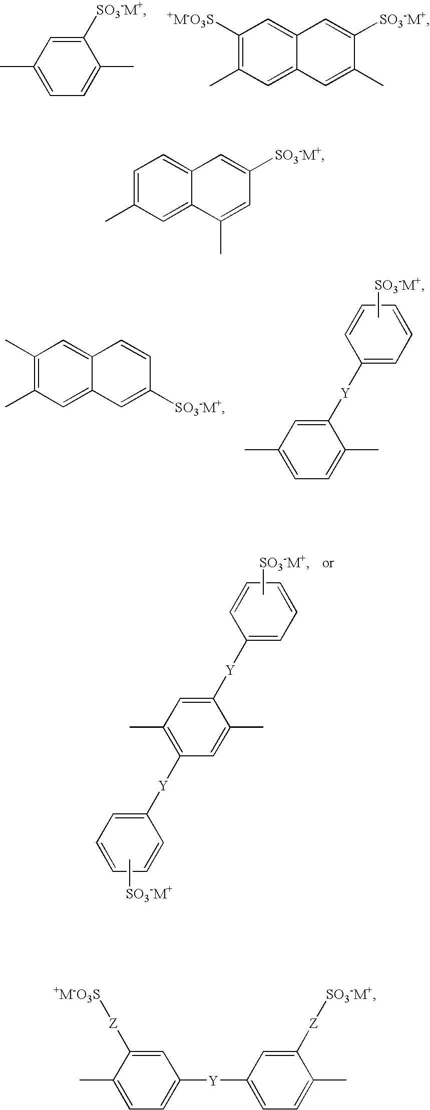
wherein Z represents a direct bond between a carbon atom of benzene and —SO3-M+ such as, 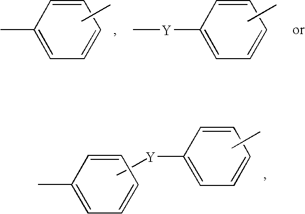
wherein Y represents a carbon-carbon single bond such as 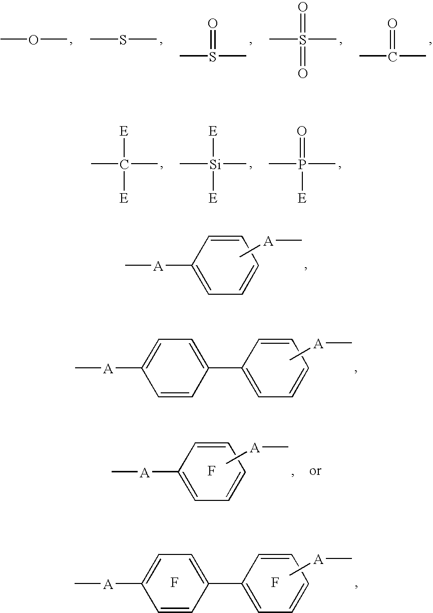
wherein A represents a carbon-carbon single bond such as 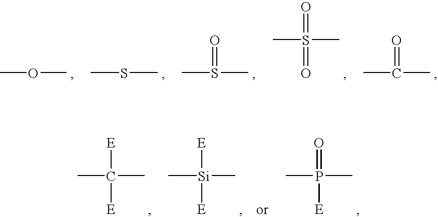
wherein E represents H, F, C1-C5 or 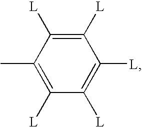
wherein L represents H, F, or C1-C5, and
wherein M+ represents a counterion having a cation charge.

3. The sulfonated poly(arylene ether) copolymer containing a crosslinkable moiety at the ends thereof as recited in claim 2,
wherein the counterion having a cation charge is a potassium ion, a sodium ion, or an alkyl amine (+NR4).

4. The sulfonated poly(arylene ether) copolymer containing a crosslinkable moiety at the ends thereof as recited in claim 1,
wherein the Ar represents 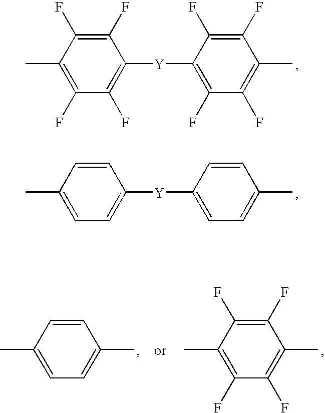
wherein Y represents a carbon-carbon single bond such as 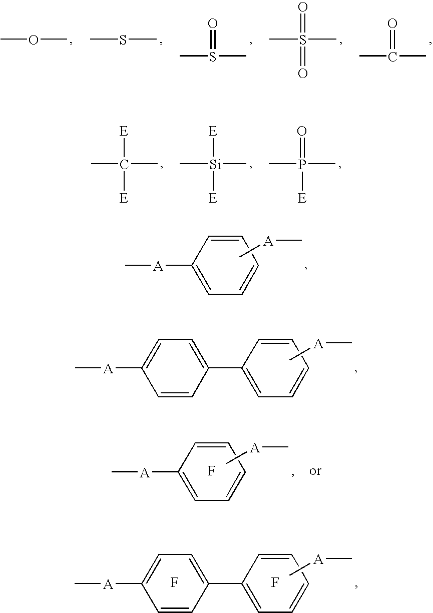
wherein A represents a carbon-carbon single bond such as 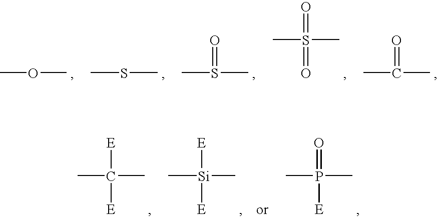
wherein E represents H, F, C1-C5 or 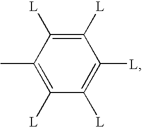
and
wherein L represents H, F, or C1-C5.

5. The sulfonated poly(arylene ether) copolymer containing a crosslinkable moiety at the ends thereof as recited in claim 1,
wherein the CM represents 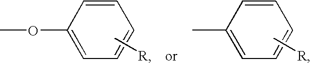
wherein R represents a triple bond (ethynyl part) 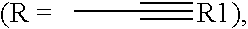
a double bond (vinyl part) 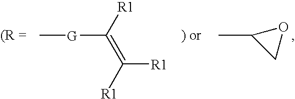
in which R1 is substituted,
wherein G represents a carbon-carbon single bond such as 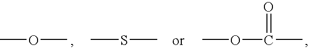
wherein R1 represents H, F, C1-C5, or, 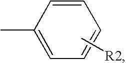
and
wherein R2 represents H, X or C1-C5

6. A method of preparing a sulfonated poly(arylene ether) copolymer containing a crosslinkable moiety at the ends thereof comprising:
forming a polymer of the following Formula 2 using a sulfonated dihydroxy monomer, a non-sulfonated dihydroxy monomer, and a non-sulfonated dihalide monomer; and
forming a sulfonated poly(arylene ether copolymer containing a crosslinkable moiety at the ends thereof of the following Formula 3 using a substitution reaction by polycondensation at the ends of the polymer: 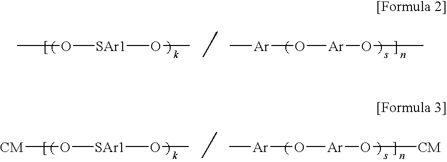
wherein SAR1 represents a sulfonated aromatic group such as, 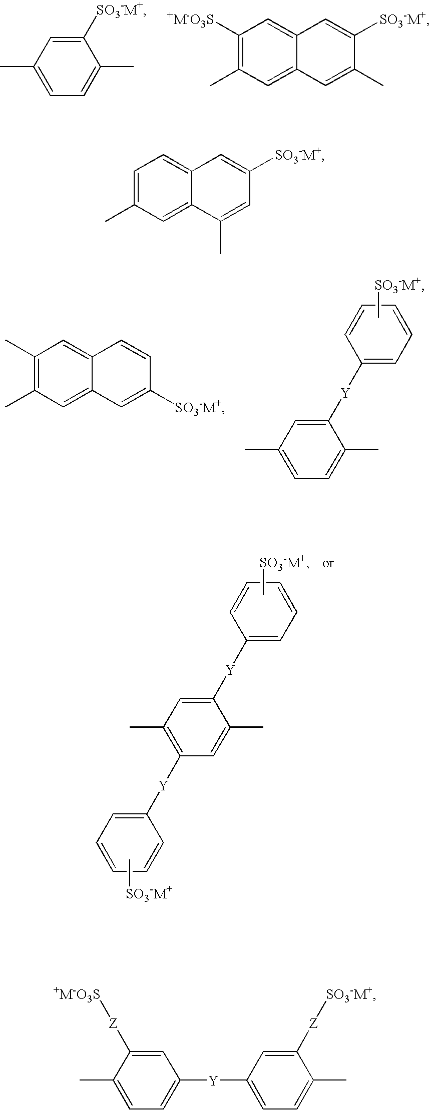
wherein the Ar represents a non-sulfonated aromatic group, such as 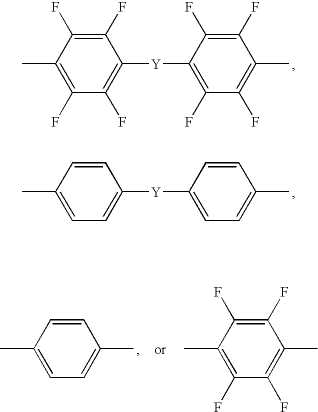
wherein Y represents a carbon-carbon single bond such as 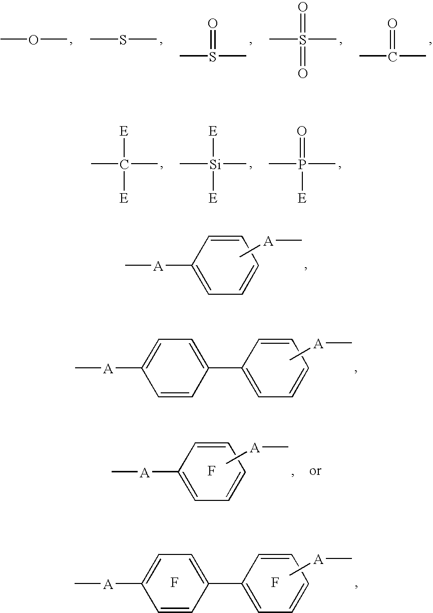
wherein A represents a carbon-carbon single bond such as 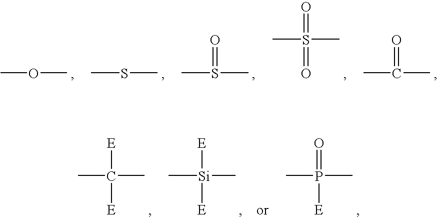
wherein E represents H, F, C1-C5 or 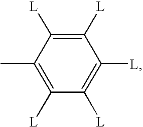
wherein L represents H, F, or C1-C5,
wherein Z represents a direct bond between a carbon atom of benzene and —SO3-M+ such as, 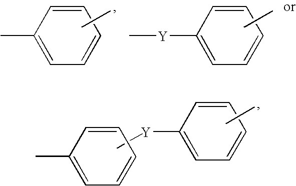
wherein M+ represents a counterion having a cation charge,
wherein CM represents a crosslinkable moiety such as 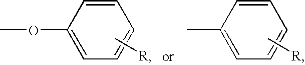
in which R represents a triple bond (ethynyl part) 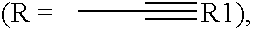
a double bond (vinyl part) 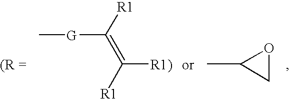
wherein G represents a carbon-carbon single bond such as 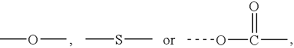
wherein R1 represents H, F, C1-C5, or, 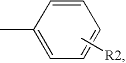
wherein R2 represents H, X or C1-C5, in which X is a halogen atom, and
wherein k has a value in the range of 0.001 to 1.000, s has a value of (1−k), and (k+s)/m represents a value in the range of 0.800 to 1.200.

7. The method of preparing a sulfonated poly(arylene ether) copolymer as recited claim 6,
wherein, in forming the polymer, a base, an azeotropic solvent and an aprotic polar solvent, or protic polar solvent are used, and the polycondensation is carried out in the temperature range of 10° C. to 300° C.

8. The method of preparing a sulfonated poly(arylene ether) copolymer as recited in claim 7,
wherein the aprotic polar solvent includes one selected from the group consisting of N-methylpyrrolidone (NMP), dimethylformamide (DMF), N,N-dimethylacetamide (DMAc) and dimethylsulfoxide (DMSO), the protic polar solvent includes one selected from the group consisting of methylene chloride (CH₂Cl₂), chloroform (CH₃Cl) and tetrahydrofuran (THF), and the azeotropic solvent includes one selected from the group consisting of benzene, toluene and xylene.

9. The method of preparing a sulfonated poly(arylene ether) copolymer as recited in claim 6,
wherein the substitution reaction uses a halide-substituted monomer 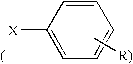
or a hydroxy-substituted monomer

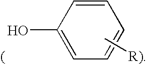

10. The method of preparing a sulfonated poly(arylene ether) copolymer as recited in claim 9,
wherein the halide-substituted monomer is used if the (k+s)/m has a value of more than 1, the hydroxy-substituted monomer is used if the (k+s)/m has a value of less than 1, and the hydroxy-substituted monomer is used if the R2 is X.

11. A sulfonated poly(arylene ether) copolymer containing a crosslinkable moiety at the ends thereof, represented by the following Formula 4: 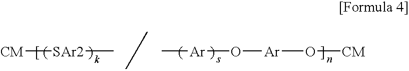
wherein SAr2 represents a sulfonated aromatic group, Ar represents a non-sulfonated aromatic group, CM represents a crosslinkable moiety, k has a value in the range of 0.001 to 1.000, s has a value of (1−k), and n represents an integer from 10 to 500 to represent a repeating unit of a polymer.

12. The method of preparing a sulfonated poly(arylene ether) copolymer as recited in claim 11,
wherein the SAr2 represents 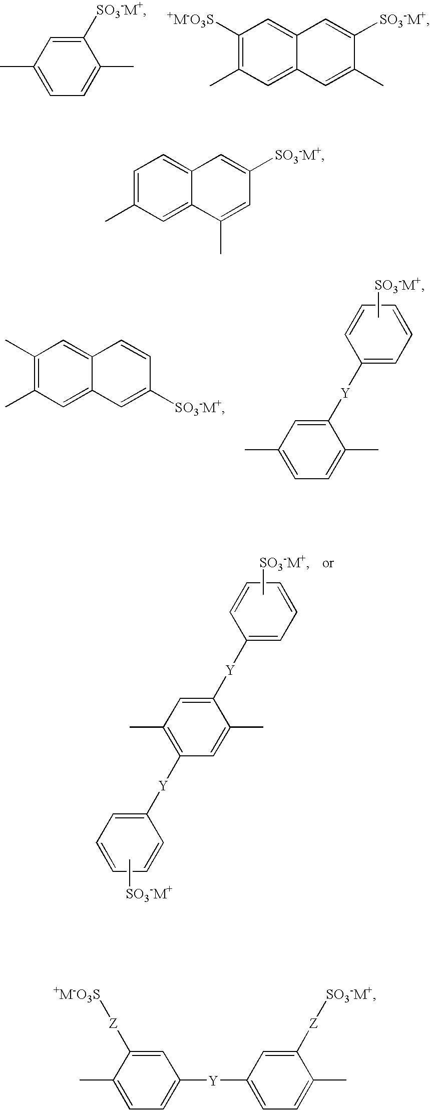
wherein the Ar represents 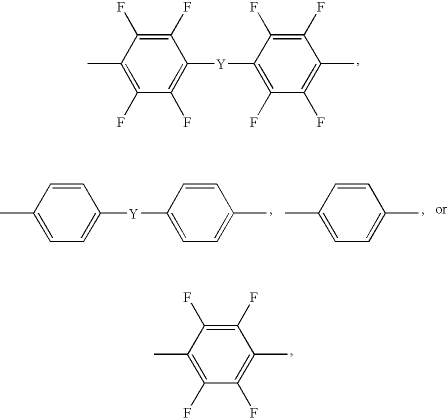
wherein Y represents a carbon-carbon single bond such as 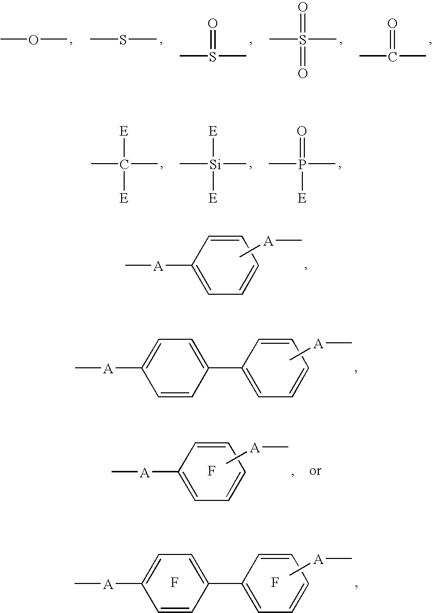
wherein A represents a carbon-carbon single bond such as 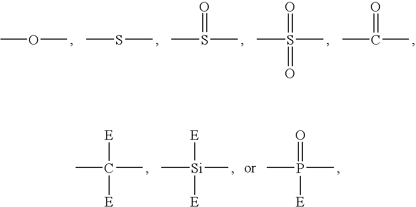
wherein E represents H, F, C1-C5 or 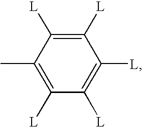
wherein L represents H, F, or C1-C5,
wherein Z represents a direct bond between a carbon atom of benzene and —SO3-M+ such as, 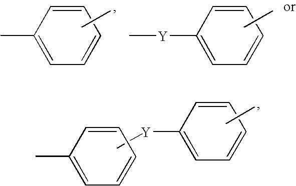
and
wherein M+ represents a counterion having a cation charge such as a potassium ion, a sodium ion, or an alkyl amine.

13. The method of preparing a sulfonated poly(arylene ether) copolymer as recited in claim 11,
wherein the CM represents 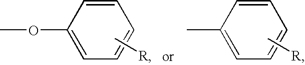
wherein R represents a triple bond (ethynyl part) (R=—≡R1), a double bond (vinyl part) 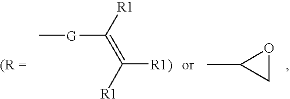
in which R1 is substituted,
wherein G represents a carbon-carbon single bond such as 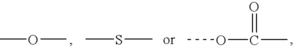
wherein R1 represents H, F, C1-C5, or, 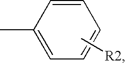
wherein R² represents H, X or C1-C5, and
wherein X represents a halogen atom.

14. A method of preparing a sulfonated poly(arylene ether) copolymer containing a crosslinkable moiety at the ends thereof comprising:
forming a polymer of the following Formula 5 using a sulfonated dihydroxy monomer, a non-sulfonated dihydroxy monomer, and a non-sulfonated dihalide monomer; and
forming a sulfonated poly(arylene ether copolymer containing a crosslinkable moiety at the ends thereof of the following Formula 6 using a substitution reaction by polycondensation at the ends of the polymer: 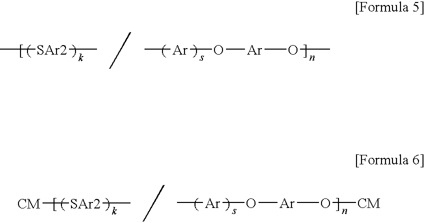
wherein the SAr2 represents a sulfonated aromatic group such as, 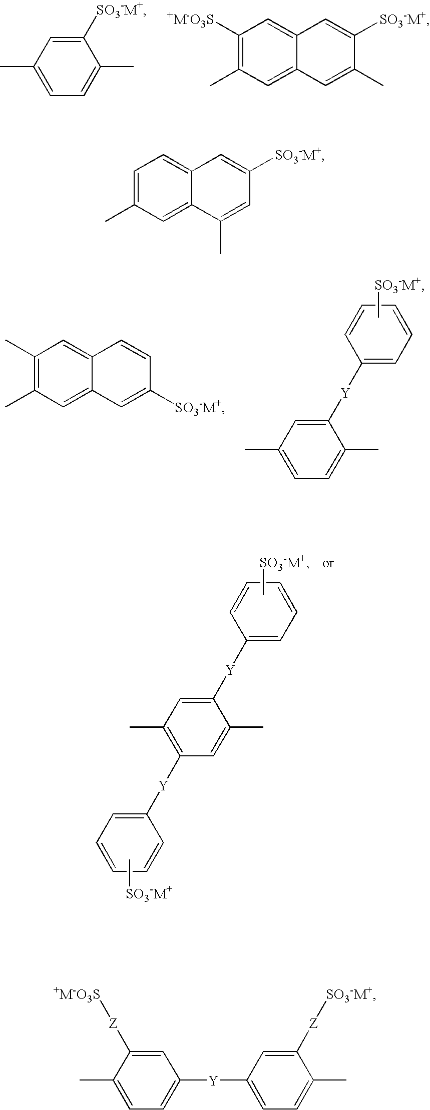
wherein the Ar represents a non-sulfonated aromatic group, such as 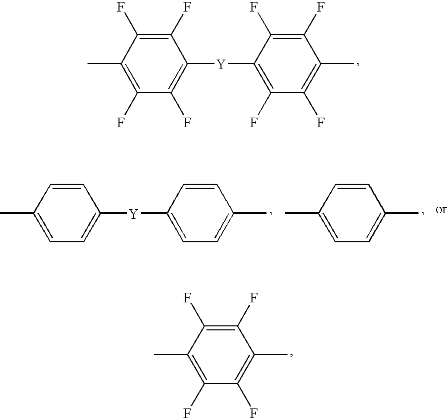
wherein Y represents a carbon-carbon single bond such as 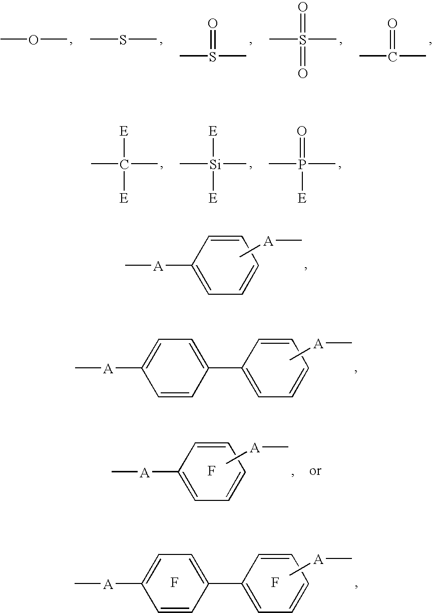
wherein A represents a carbon-carbon single bond such as 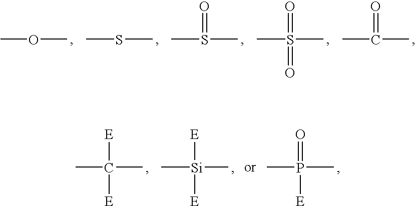
wherein E represents H, F, C1-C5 or 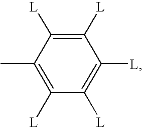
wherein L represents H, F, or C1-C5,
wherein Z represents a direct bond between a carbon atom of benzene and —SO3-M+ such as, 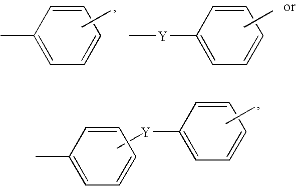
wherein M+ represents a counter ion having a cation charge such as a potassium ion, a sodium ion, or an alkyl amine,
wherein CM represents a crosslinkable moiety such as 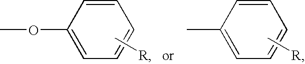
in which R represents a triple bond (ethynyl part) 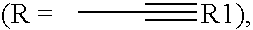
a double bond (vinyl part) 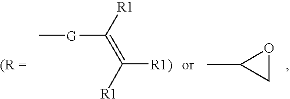
wherein G represents a carbon-carbon single bond such as 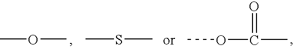
wherein R1 represents H, F, C1-C5, or 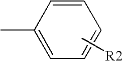
wherein R2 represents H, X or C1-C5, in which X is a halogen atom.

15. The method of preparing a sulfonated poly(arylene ether) copolymer containing a crosslinkable moiety at the ends thereof as recited in claim 14,
wherein, in forming the polymer, a base, an azeotropic solvent and an aprotic polar solvent, or protic polar solvent are used, and the polycondensation is carried out in the temperature range of 10° C. to 300° C.

16. The method of claim 15, wherein the aprotic polar solvent includes one selected from the group consisting of N-methylpyrrolidone (NMP), dimethylformamide (DMF), N,N-dimethylacetamide (DMAc) and dimethylsulfoxide (DMSO), the protic polar solvent includes one selected from the group consisting of methylene chloride (CH₂Cl₂), chloroform (CH₃Cl) and tetrahydrofuran (THF), and the azeotropic solvent includes one selected from the group consisting of benzene, toluene and xylene.

17. The method of claim 14, wherein the substitution reaction uses a halide-substituted monomer 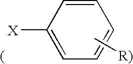
or a hydroxy-substituted monomer

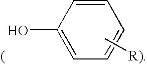

18. The method of claim 17, wherein the halide-substituted monomer is used if the (k+s)/m has a value of less than 1, the hydroxy-substituted monomer is used if the (k+s)/m has a value of more than 1, and the hydroxy-substituted monomer is used if the R2 is X, regardless of the value of (k+s)/m.
